(19) United States
(12) Patent Application Publication
(10) Pub. No.: US 2012/0307112 A1
(43) Pub. Date: Dec. 6, 2012

(54) IMAGING APPARATUS, IMAGING METHOD, AND COMPUTER READABLE RECORDING MEDIUM

(75) Inventors: Keiji Kunishige, Tokyo (JP); Manabu Ichikawa, Tokyo (JP)

(73) Assignee: OLYMPUS IMAGING CORP., Tokyo (JP)

(21) Appl. No.: 13/483,204

(22) Filed: May 30, 2012

(30) Foreign Application Priority Data
May 31, 2011 (JP) 2011-122656

(51) Int. Cl. H04N 5/262

(52) U.S. Cl. 348/239; 348/E05.051

(57) ABSTRACT

An imaging apparatus including a shooting unit consecutively generating electronic image data by imaging a subject and photoelectrically converting the imaged subject; a display unit displaying images corresponding to the image data in a generation sequence; an image processing unit generating processed image data by performing special effect processing of generating a visual effect by combining plural image processing operations with respect to the image data; an image processing controller generating plural processed image data by allowing the image processing unit to perform plural special effect processing operations with respect to the image data when there are plural special effect processing operations to be performed by the image processing unit; and a display controller collectively displaying one or more processed images corresponding to at least some of the processed image data generated by the image processing unit and an image corresponding to the image data on the display unit.

### CROSS REFERENCE TO RELATED APPLICATION

This application is based upon and claims the benefit of priority from Japanese Patent Application No. 2011-122656, filed on May 31, 2011, the entire contents of which are incorporated herein by reference.

### FIELD OF INVENTION

The present invention relates to an imaging apparatus, an imaging method, and a computer readable recording medium that generate electronic image data by imaging a subject and photoelectrically converting the imaged subject.

### BACKGROUND

### Description of the Related Art

In recent years, in an imaging apparatus such as a digital camera or a digital video camera, various shooting modes including a shooting mode in which a natural image can be captured even in any shooting scene or a shooting mode in which a clearer image can be captured are loaded. In these shooting modes, a variety of shooting conditions including a contrast, sharpness, and a chroma are set to capture an image having a natural image quality with various shooting scenes.

Meanwhile, there has been known an imaging apparatus loaded with a special effect shooting mode to perform special effect processing (art filter) in which an impressive image over a known image can be prepared by intentionally adding shading or noise or adjusting the chroma or contrast to a chroma or contrast which is over a known doneness category. For example, there has been known a technology that can create a shading effect within a captured image by separating image data into data of a luminance component and data of a color component and adding shading emphasized more than optical characteristics of an optical system, to the data of the luminance component (for example, Japanese Laid-open Patent Publication No. 2010-74244).

Further, there has been known a technology that can generate granularity within a captured image by superimposing a predetermined granular pattern and correcting a contrast with respect to concurrent image data (for example, Japanese Laid-open Patent Publication No. 2010-62836).

There has been known an imaging apparatus loaded with a bracket shooting mode to record a plurality of image data by one-time shooting operation while changing various shooting conditions while shooting, for example, parameters including a white balance, an ISO photographic sensitivity, and an exposure value (for example, Japanese Laid-open Patent Publication No. 2002-142148).

### SUMMARY

An imaging apparatus according to an aspect of the present invention includes: a shooting unit that consecutively generates electronic image data by imaging a subject and photoelectrically converting the imaged subject; a display unit that displays images corresponding to the image data in a generation sequence; an image processing unit that generates processed image data by performing special effect processing of generating a visual effect by combining a plurality of image processing operations with respect to the image data; an image processing controller that causes to generate a plurality of processed image data by allowing the image processing unit to perform the plurality of kinds of special effect processing operations with respect to the image data when there are the plurality of kinds of special effect processing operations to be performed by the image processing unit; and a display controller that collectively displays one or a plurality of processed images corresponding to at least some of the plurality of processed image data generated by the image processing unit and an image corresponding to the image data on the display unit.

An imaging method according to another aspect of the present invention is performed by an imaging apparatus including a shooting unit that consecutively generates electronic image data by imaging a subject and photoelectrically converting the imaged subject and a display unit that displays images corresponding to the image data in a generation sequence, the method including: generating processed image data by performing special effect processing of generating a visual effect by combining a plurality of image processing operations with respect to the image data; generating a plurality of processed image data by performing the plurality of kinds of special effect processing operations in the image processing with respect to one image datum when there are the plurality of special effect processing operations; and collectively displaying one or a plurality of processed images corresponding to at least some of the plurality of processed image data generated by the image processing unit and an image corresponding to one image datum on the display unit.

A non-transitory computer-readable storage medium according to still another aspect of the present invention is stored with an executable program thereon, wherein the program instructs a processor of an imaging apparatus including a shooting unit that consecutively generates electronic image data by imaging a subject and photoelectrically converting the imaged subject and a display unit that displays images corresponding to the image data in a generation sequence to perform: generating processed image data by performing special effect processing of generating a visual effect by combining a plurality of image processing operations with respect to the image data; generating a plurality of processed image data by performing the plurality of kinds of special effect processing operations in the image processing with respect to one image datum when there are the plurality of kinds of special effect processing operations; and collectively displaying one or a plurality of processed images corresponding to at least some of the plurality of processed image data and an image corresponding to one image datum on the display unit.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration of a part of an imaging apparatus which is touched by a user according to a first exemplary embodiment of the present invention;

FIG. 2 is a block diagram illustrating a configuration of the imaging apparatus according to the first exemplary embodiment of the present invention;

FIG. 3 is a diagram illustrating one example of an image processing information table as the image processing information recorded by the image processing information recording portion of the imaging apparatus according to the first exemplary embodiment of the present invention;

FIG. 4 is a diagram illustrating one example of screen transition on the menu screen displayed by the display unit when the menu switch of the imaging apparatus is operated according to the first exemplary embodiment of the present invention;

FIG. 5 is a diagram illustrating another example of screen transition on the menu screen displayed by the display unit when the menu switch of the imaging apparatus is operated according to the first exemplary embodiment of the present invention;

FIG. 6 is a flowchart illustrating an outline of processing performed by the imaging apparatus according to the first exemplary embodiment of the present invention;

FIG. 7 is a flowchart illustrating an outline of the live view image display processing illustrated in FIG. 6;

FIG. 8 is a diagram illustrating one example of the live view image which the display controller displays on the display unit;

FIG. 9 is a flowchart illustrating an outline of the recording view display processing illustrated in FIG. 6;

FIG. 10 is a diagram illustrating an outline of a timing chart when the image processing controller allows the image processing unit to execute each of the plurality of special effect processing operations and doneness effect processing operations with respect to the image data;

FIG. 11 is a diagram illustrating a method of displaying an image which the display controller recording view-displays on the display unit;

FIG. 12 is a diagram illustrating one example of the live view image which the display controller displays on the display unit according to a first modified example of the first exemplary embodiment of the present invention;

FIG. 13 is a diagram illustrating one example of the live view image which the display controller displays on the display unit according to a second modified example of the first exemplary embodiment of the present invention;

FIG. 14 is a diagram illustrating one example of the live view image which the display controller displays on the display unit according to a third modified example of the first exemplary embodiment of the present invention;

FIG. 15 is a flowchart illustrating an outline of the recording view display processing of an operation performed by the imaging apparatus according to a second exemplary embodiment of the present invention;

FIG. 16 is a block diagram illustrating a configuration of flash memory according to a third exemplary embodiment of the present invention;

FIG. 17 is a diagram illustrating one example of an image processing information table recorded by the image processing information recording portion as visual information according to the third exemplary embodiment of the present invention;

FIG. 18 is a flowchart illustrating an outline of the live view image display processing by the imaging apparatus according to the third exemplary embodiment of the present invention;

FIG. 19 is a diagram illustrating one example of the live view image which the display controller displays on the display unit according to the third exemplary embodiment of the present invention;

FIG. 20 is a flowchart illustrating an outline of the recording view-display processing by the imaging apparatus according to the third exemplary embodiment of the present invention;

FIG. 21 is a diagram illustrating one example of the live view image which the display controller displays on the display unit according to a first modified example of the third exemplary embodiment of the present invention;

FIG. 22 is a flowchart illustrating an outline of the recording view-display processing by the imaging apparatus according to a fourth exemplary embodiment of the present invention; and

FIG. 23 is a flowchart illustrating an outline of the picture bracket display recording processing illustrated in FIG. 22.

### DETAILED DESCRIPTION OF THE PREFERRED EMBODIMENTS

### First Exemplary Embodiment

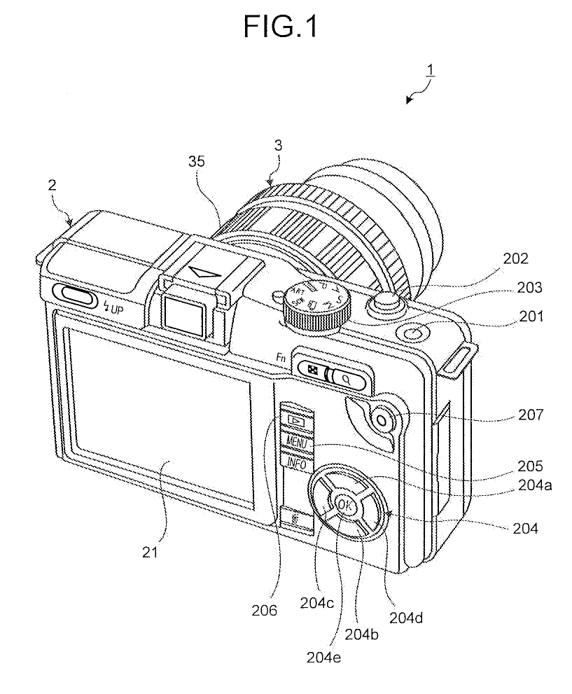

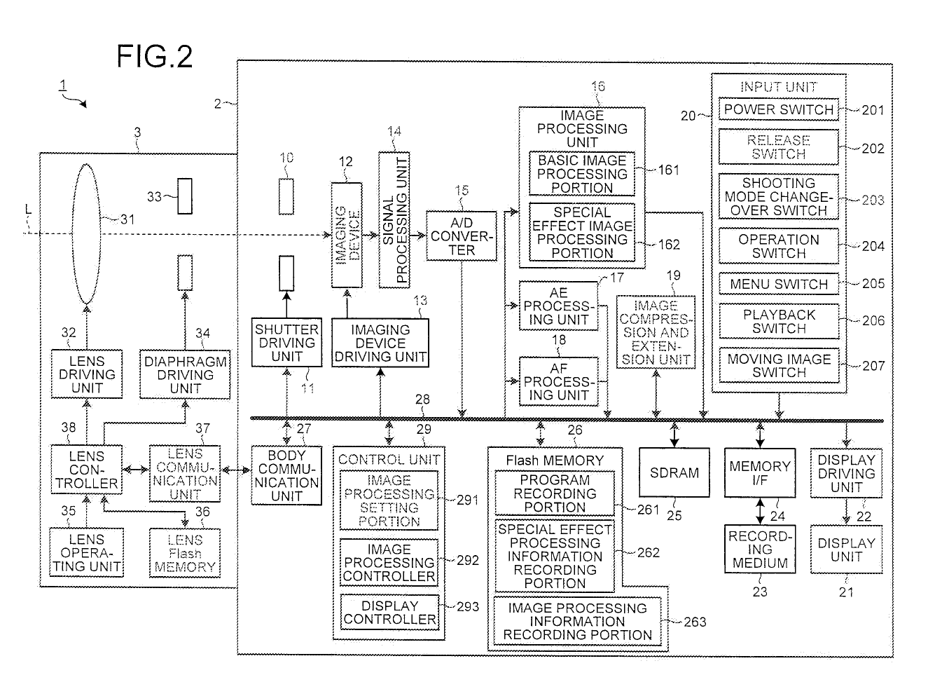

FIG. 1 is a perspective view illustrating a configuration of a part (front side) of an imaging apparatus which is touched by a user according to a first exemplary embodiment of the present invention. FIG. 2 is a block diagram illustrating a configuration of the imaging apparatus according to the first exemplary embodiment of the present invention. An imaging apparatus 1 illustrated in FIGS. 1 and 2 includes a body part 2 and a lens part 3 which is attachable to/detachable from the body part 2.

The body part 2 includes a shutter 10, a shutter driving unit 11, an imaging device 12, an imaging device driving unit 13, a signal processing unit 14, an A/D converter 15, an image processing unit 16, an AE processing unit 17, an AF processing unit 18, an image compression and extension unit 19, an input unit 20, a display unit 21, a display driving unit 22, a recording medium 23, a memory I/F 24, SDRAM (synchronous dynamic random access memory) 25, flash memory 26, a body communication unit 27, a bus 28, and a control unit 29.

The shutter 10 sets a state of the imaging device 12 to an exposure state or a shielding state. The shutter driving unit 11 is configured by using a stepping motor and drives the shutter 10 according to an instruction signal inputted from the control unit 29.

The imaging device 12 is configured by using a CCD (charge coupled device) or a CMOS (complementary metal oxide semiconductor) that receives light focused by the lens part 3 and converting the received light into an electric signal. The imaging device driving unit 13 outputs image data (analog signal) from the imaging device 12 to the signal processing unit 14 at a predetermined timing. In this sense, the imaging device driving unit 13 serves as an electronic shutter.

The signal processing unit 14 performs analog processing of the analog signal inputted from the imaging device 12 and outputs the corresponding signal to the A/D converter 15. In detail, the signal processing unit 14 performs noise reduction processing and gain-up processing of the analog signal. For example, the signal processing unit 14 reduces reset noise and thereafter, performs waveform shaping and additionally, performs gain-up to achieve desired brightness, with respect to the analog signal.

The A/D converter 15 performs A/D conversion of the analog signal inputted from the signal processing unit 14 to generate digital image data and outputs the generated digital image data to the SDRAM 25 through the bus 28.

The image processing unit 16 acquires the image data from the SDRAM 25 through the bus 28 and generates processed image data by performing various image processing of the acquired image data (RAW data). The processed image data is outputted to the SDRAM 25 through the bus 28. The image processing unit 16 includes a basic image processing portion 161 and a special effect image processing portion 162.

The basic image processing portion 161 performs basic image processing including optical black subtraction processing, white balance adjustment processing, concurrent processing of the image data when the imaging device is a bayer array, color matrix computation processing, γ correction processing, color reproduction processing, and edge emphasis processing. Further, the basic image processing portion 161 generates doneness effect image data by performing doneness effect processing of reproducing a natural image based on a predetermined parameter of each image processing. Herein, the parameter of each image processing is the contrast, the sharpness, the chroma, the white balance, and a gradation value.

The special effect image processing portion 162 performs special effect processing that generates a visual effect by combining a plurality of image processing with respect to the image data to generate the processed image data (hereinafter, referred to as “special effect image data”). The combination of the special effect processing is a combination including any one of, for example, tone curve processing, airbrushing, shading addition processing, image synthesis processing, noise superimposition processing, and chroma adjustment processing and image synthesis processing.

The AE processing unit 17 acquires the image data recorded in the SDRAM 25 through the bus 28 and sets an exposure condition at the time of still image capturing or moving image capturing based on the acquired image data. In detail, the AE processing unit 17 calculates luminance from the image data and performs automatic exposure of the imaging apparatus 1 by determining, for example, a set value of an aperture value (F value), a shutter speed, and the like based on the calculated luminance.

The AF processing unit 18 acquires the image data recorded in the SDRAM 25 through the bus 28 and adjusts an automatic focus of the imaging apparatus 1 based on the acquired image data. For example, the AF processing unit 18 extracts a signal of a high-frequency component from the image data, performs AF (auto focus) computation processing with respect to the signal of the high-frequency component, and determines focus point setting evaluation to adjust the automatic focus of the imaging apparatus 1.

The image compression and extension unit 19 acquires the image data from the SDRAM 25 through the bus 28, compresses the acquired image data according to a predetermined format, and outputs the compressed image data to the SDRAM 25. Herein, the predetermined format includes a JPEG (joint photographic experts group) format, a MotionJPEG format, and an MP4 (H.264) format. Further, the image compression and extension unit 19 acquires the image data (compressed image data) recorded in the recording medium 23 through the bus 28 and the memory I/F 24 and extends (stretches) the acquired image data and outputs the corresponding data to the SDRAM 25.

The input unit 20 includes a power switch 201 switching a power state of the imaging apparatus 1 to an on state or an off state, a release switch 202 receiving an input of a still image release signal instructing capturing of a still image, a shooting mode change-over switch 203 changing over various shooting modes set in the imaging apparatus 1, an operation switch 204 changing over various settings of the imaging apparatus 1, a menu switch 205 displaying various set-ups of the imaging apparatus 1 on the display unit 21, a playback switch 206 displaying an image corresponding to image data recorded in the recording medium 23 on the display unit 21, and a moving image switch 207 receiving an input of a moving image release signal instructing capturing of the moving image.

The release switch 202 may be advanced and retreated by external pressing force and when the release switch 202 is pressed halfway, an input of a first release signal instructing a shooting preparation operation is received, whereas when the release switch 202 is pressed fully, an input of a second release signal instructing capturing of the still image is received. The operation switch 204 includes respective upper and lower and left and right direction switches 204a to 204d that performs selection setting on a menu screen and a determination switch 204e (OK switch) that determines operations by the respective direction switches 204a to 204d on the menu screen (see FIG. 1). Further, the operation switch 204 may be configured by using a dial switch. By installing a touch panel on a display screen of the display unit 21 as a part of the input unit 20, a user may input an instruction signal on the display screen of the display unit 21.

The display unit 21 is configured by using a display panel made of liquid crystals or organic EL (electro luminescence). The display driving unit 22 acquires the image data recorded in the SDRAM 25 or the image data recorded in the recording medium 23 through the bus 28 and displays an image corresponding to the acquired image data on the display unit 21. Herein, the display of the image includes a recording view display of displaying image data just after shooting only for a predetermined time period (for example, for 3 seconds), a playback display of playing back the image data recorded in the recording medium 23, and a live view display of sequentially displaying a live view image corresponding to image data consecutively generated by the imaging device 12 according to a temporal sequence. Further, the display unit 21 appropriately displays operation information of the imaging apparatus 1 and information on shooting.

The recording medium 23 is configured by using a memory card mounted from the outside of the imaging apparatus 1. The recording medium 23 is mounted to be attached to and detached from the imaging apparatus 1 through the memory I/F 24. The image data processed by the image processing unit 16 or the image compression and extension unit 19 is written in the recording medium by a recording device (not illustrated) according to a type of the recording medium 23 or the image data recorded in the recording medium 23 is read out by the recording device. Further, the recording medium 23 may output a shooting program and various pieces of information to the flash memory 26 through the memory I/F 24 and the bus 28 under the control of the control unit 29.

The SDRAM 25 is configured by using volatile memory. The SDRAM 25 temporarily records the image data inputted from the A/D converter 15 through the bus 28, the processed image data inputted from the image processing unit 16, and information of the imaging apparatus 1, which is being processed. For example, the SDRAM 25 temporarily records image data sequentially outputted by the imaging device 12 for each frame through the signal processing unit 14, the A/D converter 15 and the bus 28.

The flash memory 26 is configured by using non-volatile memory. The flash memory 26 includes a program recording portion 261, a special effect processing information recording portion 262, and an image processing information recording portion 263. The program recording portion 261 records various programs for operating the imaging apparatus 1, a shooting program, various data used while the program is being executed, and various parameters required for the image processing operation by the image processing unit 16. The special effect processing information recording portion 262 records combination information of image processing in each special effect processing performed by the special effect image processing portion 162. The image processing information recording portion 263 records image processing information in which a processing time corresponds to the image processing which can be executed by the image processing unit 16. Further, the flash memory 26 records a manufacturing number for specifying the imaging apparatus 1.

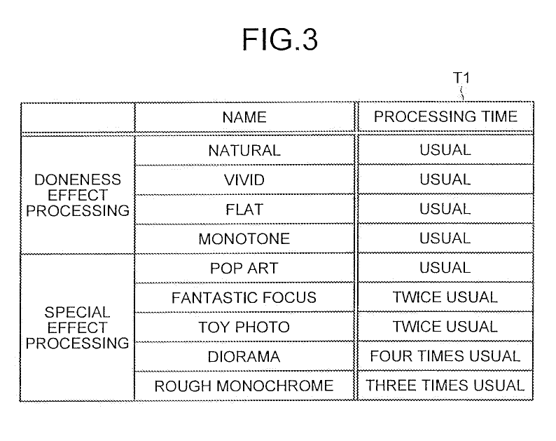

Herein, the image processing information recorded by the image processing information recording portion 263 will be described. FIG. 3 is a diagram illustrating one example of an image processing information table as the image processing information recorded by the image processing information recording portion 263.

As illustrated in FIG. 3, in an image processing information table T1, a processing time depending on each image processing is written to correspond to each of doneness effect processing and special effect processing which the image processing unit 16 can execute with respect to the image data. For example, when the doneness effect processing set in the image processing unit 16 is “natural”, “usual” is described as the processing time. Herein, the “usual” is a processing time when the basic image processing portion 161 can perform the image processing without a delay with respect to the image data which the imaging device 12 consecutively generates at a predetermined frame rate (for example, 60 fps). Contrary to this, when the special effect processing set in the image processing unit 16 is a “fantastic focus”, “twice usual” is described as the processing time.

As such, in the image processing information table T1, the processing time is written to correspond to each of the doneness effect processing and the special effect processing which the image processing unit 16 performs.

Herein, each of the doneness effect processing and the special effect processing will be described. In the first exemplary embodiment, the basic image processing portion 161 has a function of performing four doneness effect processing operations. Processing items of the doneness effect processing include “Natural”, “Vivid”, “Flat”, and “Monotone”. The special effect image processing portion 162 has a function to perform 5 special effect processing operations. The special effect image processing portion 162 has a function of performing pop art, fantastic focus, toy photo, diorama, and rough monochrome as processing items of the special effect processing.

First, a processing content of the doneness effect processing will be described.

The doneness effect processing corresponding to the processing item “Natural” is the processing in which the captured image is done by a natural color.

The doneness effect processing corresponding to the processing item “Vivid” is the processing in which the color of the captured image is done clearly.

The doneness effect processing corresponding to the processing item “Flat” is the processing in which a captured subject image is done by placing emphasis on a material property of the captured subject.

The doneness effect processing corresponding to the processing item “Monotone” is the processing in which the captured image is done by a monochrome tone.

Subsequently, a processing content of the special effect processing will be described.

The doneness effect processing corresponding to the processing item pop art is the processing that emphasizes a color colorfully and expresses the color in a bright and pleasant atmosphere. A combination of the image processing of pop art includes, for example, chroma emphasis processing and contrast emphasis processing.

The doneness effect processing corresponding to the processing item fantastic focus is the processing expressed beautifully and fantastically with a feeling being surrounded by happy light while a detail of the subject remains while an air sense is expressed within a smooth tone. A combination of the image processing of the fantastic focus includes, for example, tone curve processing, airbrushing, alpha blend processing, and image synthesis processing.

The doneness effect processing corresponding to the processing item toy photo is the processing of expressing antiqueness or a remembrance sense by performing a shading effect with respect to the vicinity of the image. A combination of the image processing of the toy photo includes, for example, low pass filter processing, white balance processing, contrast processing, shading processing, and color chroma processing.

The doneness effect processing corresponding to the processing item diorama is the processing of expressing toyishness and imitativeness by executing an extreme blurring effect with respect to the vicinity of the image. A combination of the image processing of the diorama includes, for example, color chroma processing, contrast processing, airbrushing, and synthesis processing (see, for example, Japanese Laid-open Patent Publication No. 2010-74244 for detailed contents of the toy photo and the shading).

The doneness effect processing corresponding to the processing item rough monochrome is the processing expressing roughness by adding extreme contrast and granular noise of a film. A combination of the image processing of the rough monochrome includes, for example, edge enhancement processing, level correction optimization processing, noise pattern superimposition processing, synthesis processing, and contrast processing (see, for example, Japanese Laid-open Patent Publication No. 2010-62836 for a detailed content of the rough monochrome).

The body communication unit 27 is a communication interface for communicating with the lens part 3 mounted on the body part 2.

The bus 28 is configured by using a transmission channel connecting respective constituent components of the imaging apparatus 1. The bus 28 transmits various data generated in the imaging apparatus 1 to each constituent component of the imaging apparatus 1.

The control unit 29 is configured by using a CPU (central processing unit). The control unit 29 integrally controls an operation of the imaging apparatus 1 by transmitting an instruction or data corresponding to each component constituting the imaging apparatus 1 according to an instruction signal or a release signal from the input unit 20 through the bus 28. The control unit 29 performs a control of starting the shooting operation in the imaging apparatus 1 when a second release signal is inputted. Herein, the shooting operation in the imaging apparatus 1 represents an operation in which the signal processing unit 14, the A/D converter 15, and the image processing unit 16 perform predetermined processing of the image data outputted by the imaging device 12 by the driving of the shutter driving unit 11 and the imaging device driving unit 13. The processed image data is compressed by the image compression and extension unit 19 and recorded in the recording medium 23 through the bus 28 and the memory I/F 24, under a control of an image processing controller 292.

A detailed configuration of the control unit 29 will be described. The control unit 29 includes an image processing setting portion 291, the image processing controller 292, and a display controller 293.

The image processing setting portion 291 sets a content of image processing to be executed in the image processing unit 16 according to the instruction signal from the input unit 20, which is inputted through the bus 28. In detail, the image processing setting portion 291 sets a plurality of special effect processing operations and doneness effect processing operations of which the processing contents are different from each other, according to an instruction signal from the input unit 20.

The image processing controller 292 generates a plurality of processed image data by allowing the image processing unit 16 to perform the plurality of kinds of special effect processing operations and doneness effect processing operations with one image datum when there are the plurality of special effect processing operations and doneness effect processing operations which should be performed by the image processing unit 16. In detail, when a picture bracket mode is set in the imaging apparatus 1, the image processing controller 292 allows the image processing unit 16 to execute the plurality of special effect processing operations which the image processing setting portion 291 sets in the image processing unit 16 with respect to the image data to generate a plurality of special effect image data and record the generated data in the SDRAM 25. Further, the image processing setting portion 291 allows the image processing unit 16 to perform the plurality of kinds of special effect processing operations and doneness effect processing operations with respect to one image datum generated just after an input of the second release signal is received to generate the plurality of processed image data.

The display controller 293 controls a display aspect of the display unit 21. In detail, the display controller 293 drives the display driving unit 22 and the image processing controller 292 displays the live view image corresponding to the processed image data generated by the image processing unit 16 on the display unit 21. Further, the display controller 293 displays one or a plurality of special effect images or live view images corresponding to at least some of the plurality of special effect image data which the image processing controller 292 generates in the image processing unit 16 on the display unit 21. For example, the display controller 293 superimposes a plurality of special effect images corresponding to the plurality of special effect image data generated when the special effect image processing portion 162 performs the plurality of special effect processing operations of which processing contents are different from each other with respect to one image datum, on the live view images which the display unit 21 consecutively displays according to the temporal sequence, which is displayed on the display unit 21. Further, the display controller 293 displays a reduced image (thumbnail image) acquired by reducing the special effect image to a predetermined size on the display unit 21. Further, the display controller 293 superimposes and displays information on a processing name of the special effect image displayed by the display unit 21, for example, an icon or a character.

The body part 2 having the above configuration may include a voice input/output function, a flash function, an attachable/detachable electronic view finder (EVF), and a communication unit which can interactively communicate with an external processing device (not illustrated) such as a personal computer through the Internet.

The lens part 3 includes an optical system 31, a lens driving unit 32, a diaphragm 33, a diaphragm driving unit 34, a lens operating unit 35, lens flash memory 36, a lens communication unit 37, and a lens controller 38.

The optical system 31 is configured by using one or a plurality of lenses. The optical system 31 focuses light from a predetermined visual field region. The optical system 31 has an optical zoom function to change an angle of view and a focus function to change a focus. The lens driving unit 32 is configured by using a DC motor or a stepping motor and moves a lens of the optical system 31 on an optical axis L to change a focus point position or the angle of view of the optical system 31.

The diaphragm 33 adjusts exposure by limiting an incident amount of the light focused by the optical system 31. The diaphragm driving unit 34 is configured by using the stepping motor and drives the diaphragm 33.

The lens operating unit 35 is a ring installed around a lens tube of the lens part 3 as illustrated in FIG. 1 and receives an input of an operation signal to start an operation of an optical zoom in the lens part 3 or an input of an instruction signal to instruct the adjustment of the focus point position in the lens part 3. Further, the lens operating unit 35 may be a push-type switch.

The lens flash memory 36 records a control program for determining a position and a movement of the optical system 31, a lens feature of the optical system 31, and various parameters.

The lens communication unit 37 is a communication interface for communicating with the body communication unit 27 of the body part 2 when the lens part 3 is mounted on the body part 2.

The lens controller 38 is configured by using the CPU (central processing unit). The lens controller 38 controls an operation of the lens part 3 according to the operation signal of the lens operating unit 35 or the instruction signal from the body part 2. In detail, the lens controller 38 performs focus point adjustment or zoom change of the lens part 3 by driving the lens driving unit 32 according to the operation signal of the lens operating unit 35 or changes an aperture value by driving the diaphragm driving unit 34. Further, the lens controller 38 may transmit focus point position information of the lens part 3, a focus distance, and unique information for identifying the lens part 3 to the body part 2 when the lens part 3 is mounted on the body part 2.

The imaging apparatus 1 having the above configuration has a picture mode and a picture bracket mode. Herein, the picture mode is a mode that selects one of the doneness effect processing and the special effect processing and generates the live view image or the still image by executing processing corresponding to the selected processing item in the image processing unit 16. Further, the picture bracket mode is a mode that generates a plurality of images which are processed differently from each other by one-time shooting operation and records the images in the recording medium 23 by selecting a desired combination of the doneness effect processing and the special effect processing and executing the selected combination in the image processing unit 16. Hereinafter, a method of setting each of the picture mode and the picture bracket mode executed by the imaging apparatus 1 will be described.

First, in the case where the user operates the power switch 201, and as a result, the display unit 21 displays the live view image with activation of the imaging apparatus 1, the display controller 293 displays a menu operation screen on the display unit 21 when the user operates the menu switch 205.

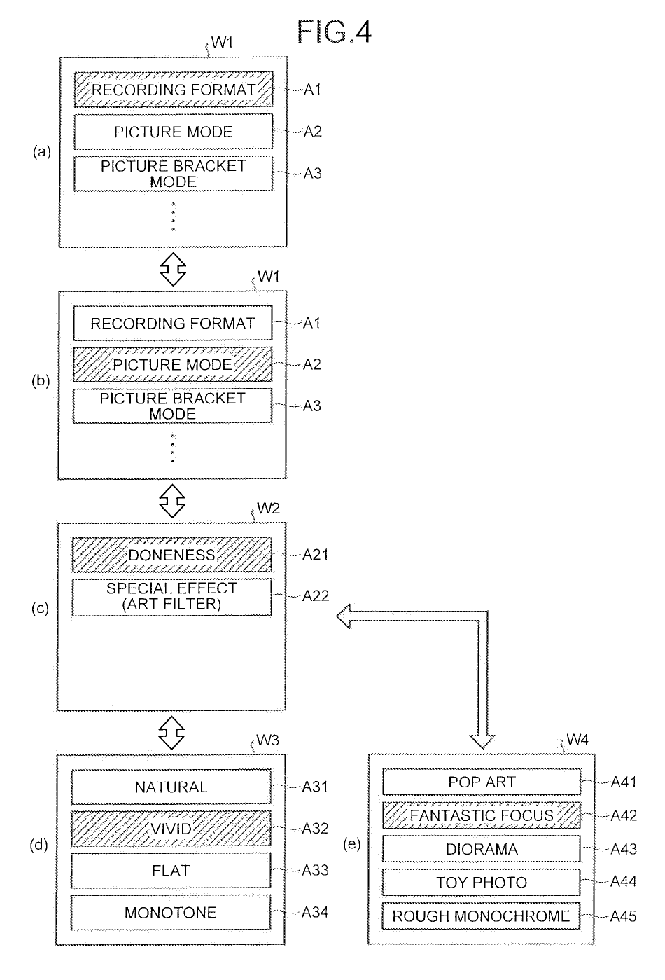

FIG. 4 is a diagram illustrating one example of screen transition on the menu screen displayed by the display unit 21 when the menu switch 205 is operated and illustrates the screen transition when the picture mode is set.

As illustrated in FIG. 4, the display controller 293 displays a menu screen W1 (FIG. 4(a)) showing a set content of the imaging apparatus 1 on the display unit 21 when the menu switch 205 is operated. A recording format icon A1, a picture mode icon A2, and a picture bracket mode icon A3 are displayed on the menu screen W1, respectively. At the time of displaying the menu image W1, the recording format icon A1 is selected as default and highlighted (color-changed) (FIG. 4(a)). Further, in FIG. 4, a highlight mark is expressed by an oblique line.

The recording format icon A1 is an icon that receives an input of an instruction signal for displaying the recording format menu screen for setting recording formats of the still image and the moving image on the display unit 21. The picture mode icon A2 is an icon that receives an input of an instruction signal for displaying a picture mode selection screen on the display unit 21. The picture bracket mode icon A3 is an icon that receives an input of an instruction signal for displaying a picture bracket mode setting screen on the display unit 21.

When the user operates a top switch 204a or a bottom switch 204b of the operation switch 204 while the display unit 21 displays the menu screen W1 to select the picture mode icon A2, the display controller 293 highlights the picture mode icon A2 on the display unit 21 (FIG. 4(b)). Further, the display controller 293 may change a font or a size with respect to the icons A1 to A3 selected by the user to display the changed font or size on the display unit 21.

When the user operates a determination switch 204e of the operation switch 204 to select the icon A2 while the display unit 21 displays the menu screen W1 (FIG. 4(b)), the display controller 293 displays a picture mode setting image W2 on the display unit 21 (FIG. 4(c)). A doneness icon A21 and a special effect icon A22 are displayed on the picture mode setting screen W2. Further, when the user operates a left switch 204c of the operation switch 204 while the display unit 21 displays the picture mode setting screen W2, the display controller 293 displays the menu screen W1 (FIG. 4(b)) on the display unit 21.

The doneness icon A21 is an icon that receives an input of an instruction signal for displaying a doneness mode selection screen on the display unit 21. The special effect icon A22 is an icon that receives an input of an instruction signal for displaying a special effect (art filter) shooting mode selection screen on the display unit 21.

When the doneness icon A21 is decided by the user while the display unit 21 displays the picture mode setting screen W2, the display controller 293 displays a doneness mode selection screen W3 on the display unit 21 (FIG. 4(d)). A Natural icon A31, a Vivid icon A32, a Flat icon A33, and a Monotone icon A34 as icons corresponding to the selectable processing items of the doneness effect processing are displayed on the doneness mode selection screen W3. Each of the icons A31 to A34 is an icon that receives an input of an instruction signal for instructing setting of processing corresponding to the doneness effect processing performed by the basic image processing portion 161. Further, FIG. 4(d) illustrates a state in which the Vivid icon A32 is selected and highlighted.

When the user operates the determination switch 204e of the operation switch 204 while the display unit 21 displays the doneness mode selection screen W3, the image processing setting portion 291 sets the doneness effect processing (Vivid in FIG. 4(d)) corresponding to the icon which the display unit 21 highlights on the doneness mode selection screen W3, as processing performed in the picture mode.

Further, when the user selects and decides the special effect icon A22 by operating the operation switch 204 while the display unit 21 displays the picture mode setting screen W2, the display controller 293 displays a special effect setting screen W4 for setting a content of special effect processing performed by the special effect image processing portion 162 on the display unit 21 (FIG. 4(e)). A pop art icon A41, a fantastic focus icon A42, a diorama icon A43, a toy photo icon A44, and a rough monochrome icon A45 as icons corresponding to the selectable processing items of the special effect processing are displayed on the special effect setting screen W4. Each of the icons A41 to A45 is an icon that receives an input of an instruction signal for instructing setting of special effect processing performed by the special effect image processing portion 162. Further, FIG. 4(e) illustrates a state in which the fantastic focus icon A42 is selected and highlighted.

When the user operates the determination switch 204e of the operation switch 204 while the display unit 21 displays the special effect setting screen W4, the image processing setting portion 291 sets the special effect processing (fantastic focus in FIG. 4(e)) corresponding to the icon which the display unit 21 highlights on the special effect setting screen W4 as processing performed in the picture mode. Further, information on the set special effect processing is recorded in the SDRAM 25.

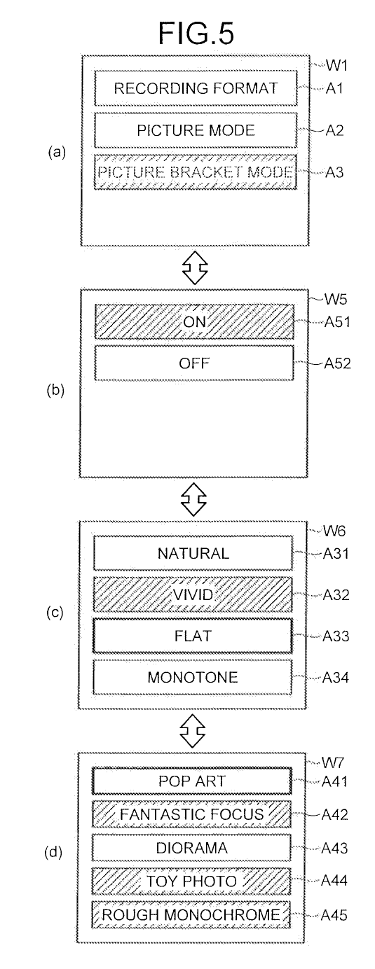

FIG. 5 is a diagram illustrating another example of screen transition on the menu screen displayed by the display unit 21 when the menu switch 205 is operated and illustrates the screen transition when the picture bracket mode is set.

As illustrated in FIG. 5(a), in the case where the display unit 21 displays the menu screen W1, when the user selects the picture bracket mode icon A3, the picture bracket mode icon A3 is highlighted.

When the user operates the determination switch 204e of the operation switch 204 while the display unit 21 displays the menu screen W1, the display controller 293 displays a picture bracket mode setting screen W5 on the display unit 21 (FIG. 5(b)). An ON icon A51 and an OFF icon A52 are displayed on the picture bracket mode setting screen W5.

The ON icon A51 is an icon that receives an input of an instruction signal for setting the picture bracket mode in the imaging apparatus 1 and sets a set flag of the picture bracket mode to an on state. The OFF icon A52 is an icon that receives an input of an instruction signal for not setting the picture bracket mode in the imaging apparatus 1 and sets the set flag of the picture bracket mode to an off state. Further, FIG. 5(b) illustrates a state in which the ON icon A51 is selected and highlighted.

When the user selects and decides the ON icon A51 by operating the operation switch 204 while the display unit 21 displays the picture bracket mode setting screen W5, the display controller 293 displays a picture bracket mode selection screen W6 on the display unit 21 (FIG. 5(c)). The icons A31 to A34 corresponding to the processing items of processing which the image processing unit 16 can execute as the picture bracket are displayed on the picture bracket mode selection screen W6.

When the user operates the determination switch 204e or the bottom switch 204b of the operation switch 204 while the display unit 21 displays the picture bracket mode selection screen W6, a processing item of selecting a predetermined icon from the picture bracket mode selection screen W6 and performing the selected icon in the picture bracket mode is set. In this case, the display controller 293 actively displays the icon selected by the user on the display unit 21 according to the operation signal inputted from the operation switch 204. Further, FIG. 5(c) illustrates a state in which the processing corresponding to the Vivid icon A32 has been set as the processing performed in the picture bracket mode and the Flat icon A33 is selected and actively displayed. Further, in FIG. 5, the active display is expressed by making a frame of the icon thick.

When the user operates the bottom switch 204b of the operation switch 204 with the actively displayed icon being the Monotone icon A34 while the display unit 21 displays the picture bracket mode selection screen W6, the display controller 293 displays a picture bracket mode selection screen W7 on the display unit 21 by scrolling the picture bracket mode selection screen W6 (FIG. 5(d)). The icons A41 to A45 corresponding to processing items of a plurality of special effect processing operations which the special effect image processing portion 162 can execute as the picture bracket mode are displayed on the picture bracket mode selection screen W7. In detail, the pop art icon A41, the fantastic focus icon A42, the diorama icon A43, the toy photo icon A44, and the rough monochrome icon A45 are displayed.

Subsequently, the user terminates setting of the picture bracket mode by operating the left switch 204c of the operation switch 204 or the release switch 202.

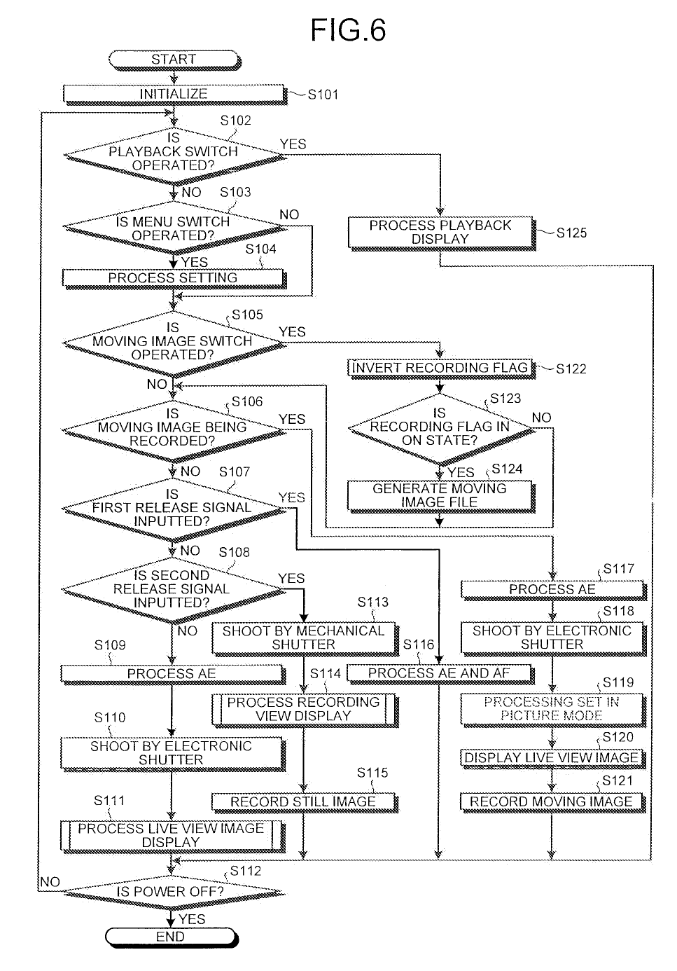

Processing of the imaging apparatus 1 in which the picture mode and the picture bracket mode are set through the above steps will be described. FIG. 6 is a flowchart illustrating an outline of processing performed by the imaging apparatus 1.

As illustrated in FIG. 6, first, when the user operates the power switch 201 to turn on a power of the imaging apparatus 1, the control unit 29 initializes the imaging apparatus 1 (step S101). In detail, the control unit 29 performs initialization to turn off a flag indicating that the moving image is being recorded. The recording flag is a flag that becomes the on state when the moving image is shot and becomes the off state when the moving image is not shot.

Subsequently, when the playback switch 206 is not operated (step S102: No) and the menu switch 205 is operated (step S103: Yes), the imaging apparatus 1 displays the menu screen W1 (see FIG. 4) and executes setting processing of setting various conditions of the imaging apparatus 1 according to the user's selection operation (step S104) and proceeds to step S105.

On the other hand, when the playback switch 206 is not operated (step S102: No) and the menu switch 205 is not operated (step S103: No), the imaging apparatus 1 proceeds to step S105.

Subsequently, the control unit 29 judges whether the moving image switch 207 is operated (step S105). When the control unit 29 judges that the moving image switch 207 is operated (step S105: Yes), the imaging apparatus 1 proceeds to step S122 to be described below. Meanwhile, when the control unit 29 judges that the moving image switch 207 is not operated (step S105: No), the imaging apparatus 1 proceeds to step S106 to be described below.

At step S106, in the case where the imaging apparatus 1 is not recording the moving image (step S106: No), when the first release signal is inputted from the release switch 202 (step S107: Yes), the imaging apparatus 1 proceeds to step S106 to be described below. Meanwhile, when the first release signal is not inputted through the release switch 202 (step S107: No), the imaging apparatus 1 proceeds to step S108 to be described below.

At step S108, a case where the second release signal is not inputted through the release switch 202 (step S108: No) will be described. In this case, the control unit 29 allows the AE processing unit 17 to execute AE processing of adjusting exposure (step S109).

Subsequently, the control unit 29 performs shooting using an electronic shutter by driving the imaging device driving unit 13 (step S110).

Thereafter, the imaging apparatus 1 executes live view image display processing of displaying the live view image corresponding to the image data generated by the imaging device 12 by the shooting using the electronic shutter on the display unit 21 (step S111). Further, the live view image display processing will be described below in detail.

Subsequently, the control unit 29 judges whether the power of the imaging apparatus 1 is turned off as the power switch 201 is operated (step S112). When the control unit 29 judges that the power of the imaging apparatus 1 is turned off (step S112: Yes), the imaging apparatus 1 terminates the processing. Contrary to this, when the control unit 29 judges that the power of the imaging apparatus 1 is not turned off (step S112: No), the imaging apparatus 1 returns to step S102.

At step S108, a case where the second release signal is inputted from the release switch 202 (step S108: Yes) will be described. In this case, the control unit 29 performs shooting using a mechanical shutter by driving each of the shutter driving unit 11 and the imaging device driving unit 13 (step S113).

Subsequently, the imaging apparatus 1 executes recording view display processing of displaying the captured still image for a predetermined time (for example, 3 seconds) (step S114). Further, the recording view display processing will be described below in detail.

Thereafter, the control unit 29 compresses the image data in the image compression and extension unit 19 in the JPEG format and records the compressed image data in the recording medium 23 (step S115). Thereafter, the imaging apparatus 1 proceeds to step S112. Further, the control unit 29 makes RAW data which is not image-processed by the image processing unit 16 correspond to the image data compressed by the image compression and extension unit 19 in the JPEG format, which may be recorded in the recording medium 23.

At step S107, the case where the first release signal is inputted from the release switch 202 (step S107: Yes) will be described. In this case, the control unit 29 allows the AE processing unit 17 to execute the AE processing of adjusting exposure and the AF processing unit 18 to execute AF processing of adjusting a focus point, respectively (step S116). Thereafter, the imaging apparatus 1 proceeds to step S112.

At step S106, the case where the imaging apparatus 1 is recording the moving image (step S106: Yes) will be described. In this case, the control unit 29 allows the AE processing unit 17 to execute the AE processing of adjusting exposure (step S117).

Subsequently, the control unit 29 performs shooting using the electronic shutter by driving the imaging device driving unit 13 (step S118).

Thereafter, the image processing controller 292 allows the image processing unit 16 to execute processing corresponding to the processing item set in the picture mode with respect to the image data (step S119). For example, the image processing controller 292 allows the basic image processing portion 161 to execute doneness processing corresponding to Vivid with respect to the image data when the processing item Vivid of the doneness processing is set in the picture mode. Further, the image processing controller 292 allows the special effect image processing portion 162 to execute the special effect processing corresponding to the fantastic focus with respect to the image data when the processing item fantastic focus of the special effect processing is set in the picture mode.

Subsequently, the display controller 293 displays on the display unit 21 the live view image corresponding to the image data which is image-processed by the image processing unit 16 (step S120).

Thereafter, the control unit 29 compresses the image data in the image compression and extension unit 19 and records the compressed image data in a moving image file prepared in the recording medium 23 as the moving image (step S121). Thereafter, the imaging apparatus 1 proceeds to step S112.

At step S105, the case where the moving image switch 207 is operated (step S105: Yes) will be described. In this case, the control unit 29 inverts the recording flag indicating that the moving image is being recorded in the on state (step S122).

Subsequently, the control unit 29 judges whether the recording flag recorded in the SDRAM 25 is in the on state (step S123). When the control unit 29 judges that the recording flag is in the on state (step S123: Yes), the control unit 29 generates, in the recording medium 23, the moving image file for recording the image data in the recording medium 23 according to the temporal sequence (step S124) and the imaging apparatus 1 proceeds to step S106. Meanwhile, when the control unit 29 judges that the recording flag is not in on state (step S123: No), the imaging apparatus 1 proceeds to step S106.

At step S102, the case where the playback switch 206 is operated (step S102: Yes) will be described. In this case, the display controller 293 acquires the image data from the recording medium 23 through the bus 28 and the memory I/F 24 and performs playback display processing of displaying the image data on the display unit 21 by extending the acquired image data to the image compression and extension unit 19 (step S125). Thereafter, the imaging apparatus 1 proceeds to step S112.

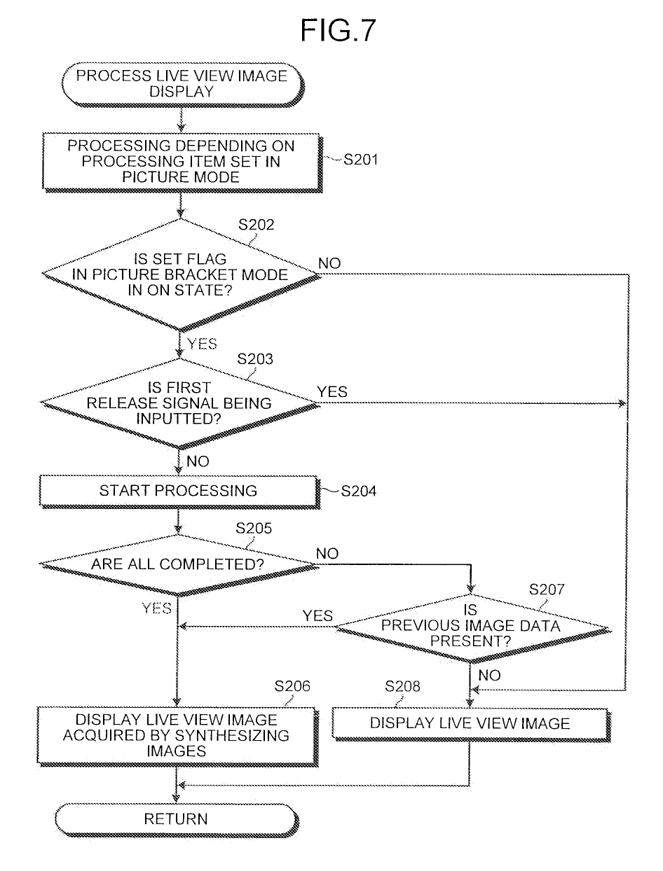

Subsequently, the live view image display processing at step S111 illustrated in FIG. 6 will be described. FIG. 7 is a flowchart illustrating an outline of the live view image display processing illustrated in FIG. 6.

As illustrated in FIG. 7, the image processing unit 16 executes, with respect to the image data, the processing depending on the processing item set in the picture mode by the image processing setting portion 291 with respect to the image data (step S201). For example, the basic image processing portion 161 acquires the image data from the SDRAM 25 through the bus 28 and generates the doneness effect image data by executing with respect to the acquired image-processed data the processing item which the image processing setting portion 291 sets in the picture mode, for example, Natural.

Subsequently, the control unit 29 judges whether the set flag in the picture bracket mode is in the on state (step S202). When the control unit 29 judges that the set flag in the picture bracket mode is in the on state (step S202: Yes), the imaging apparatus 1 proceeds to step S203 to be described below. Meanwhile, when the control unit 29 judges that the set flag in the picture bracket mode is not in the on state (step S202: No), the imaging apparatus 1 proceeds to step S208 to be described below. Further, the control unit 29 may judge whether the picture bracket mode is set in the imaging apparatus 1 by judging whether other processing items set in the picture mode are set in the basic image processing portion 161 or the special effect image processing portion 162 as the picture bracket mode.

At step S203, the control unit 29 judges whether the first release signal is being inputted through the release switch 202 (step S203). In detail, the control unit 29 judges whether the release switch 202 is in a half-pressing state by the user. When the control unit 29 judges that the first release signal is being inputted (step S203: Yes), the imaging apparatus 1 proceeds to step S208 to be described below. Meanwhile, when the control unit 29 judges that the first release signal is not being inputted (step S203: No), the imaging apparatus 1 proceeds to step S204 to be described below.

At step S204, the image processing unit 16 acquires the image data from the SDRAM 25 through the bus 28 and starts the processing corresponding to the processing item set in the picture bracket mode with respect to the acquired image data (step S204). For example, the image processing unit 16 sequentially performs processing operations corresponding to the Vivid, the fantastic focus, and the toy photo with respect to the acquired image data when the processing items Vivid, fantastic focus, and toy photo are set in the picture bracket mode. In detail, the basic image processing portion 161 generates the doneness effect image data in which the processing corresponding to the processing item Vivid is performed with respect to the acquired image data. Further, the special effect image processing portion 162 generates each of the special effect image data subjected to the processing item fantastic focus and the special effect image data subjected to the processing item toy photo with respect to the acquired image data. Further, a sequence in which the respective processing items are executed is fixed in advance and may be appropriately changed.

Subsequently, the control unit 29 judges whether the image processing unit 16 completes all of the plurality of processing items set in the picture bracket mode with respect to the image data (step S205). In detail, the control unit 29 judges whether the plurality of doneness effect image data or special effect image data in which the image processing unit 16 performs the plurality of processing items set in the picture bracket mode, respectively, are recorded in the SDRAM 25. When the control unit 29 judges that the image processing unit 16 completes all of the plurality of processing items set in the picture bracket mode with respect to the image data (step S205: Yes), the imaging apparatus 1 proceeds to step S206 to be described below. Meanwhile, when the control unit 29 judges that the image processing unit 16 does not complete any of the plurality of processing items set in the picture bracket mode with respect to the image data (step S205: No), the imaging apparatus 1 proceeds to step S207 to be described below.

At step S206, the display controller 293 synthesizes a plurality of images depending on the plurality of processing items set in the picture bracket mode with the live view image corresponding to the image data in which the processing item set in the picture mode is performed and displays the synthesized images on the display unit 21 (step S206). Thereafter, the imaging apparatus 1 returns to a main routine illustrated in FIG. 6.

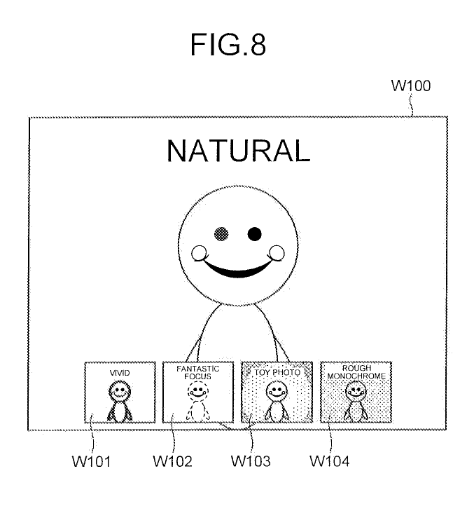

FIG. 8 is a diagram illustrating one example of the live view image which the display controller 293 displays on the display unit 21. Further, FIG. 8 illustrates one representative image among the live view images consecutively displayed by the display unit 21.

As illustrated in FIG. 8, the display controller 293 superimposes, as a thumbnail image, respective images W101 to W104 which the image processing unit 16 generates according to the plurality of processing items set in the picture mode, respectively, on a live view image W100 corresponding to the image data in which the image processing unit 16 performs the processing item set in the picture mode. Further, the display controller 293 superimposes and displays “Natural” as information on a processing item name of the live view image W100 displayed by the display unit 21.

Further, in the image W101 of FIG. 8, a contour of the subject is expressed by a thick line in order to express the processing item Vivid. Further, in the image W102, the contour of the subject is expressed by a dotted line in order to express the processing item fantastic focus. Further, in the image W103, shading is performed around the subject in order to express the processing item toy photo and further, noise (dot) is added and expressed around the subject in order to express the processing item toy photo. Further, in the image W104, the noise (dot) is superimposed and expressed in the entire image in order to express the processing item rough monochrome. Further, in FIG. 8, the display controller 293 displays each of the images W101 to W104 on the live view image W100, but may display each image on the display unit 21 in a sequence in which the image processing unit 16 completes the processing corresponding to each processing item. Further, in the case of each of the images W101 to W104, the image processing unit 16 may not perform the processing which corresponds to each processing item with respect to the same image data (asynchronous). Further, the display controller 293 may superimpose and display the information on the processing item name of each of the images W101 to W104, for example, the character or icon, on each of the images W101 to W104.

At step S205, the case where the control unit 29 judges that the image processing unit 16 does not complete any of the plurality of processing items set in the picture bracket mode with respect to the image data (step S205: No) will be described. In this case, the control unit 29 judges whether there is image data before previous processing is performed among the processing items of which processing is not completed as the processing which the image processing unit 16 performs to correspond to the processing item set in the picture bracket mode with respect to the image data (step S207). For example, the control unit 29 judges whether the special effect image data before the image processing unit 16 performs the previous special effect processing among special effect processing operations of which processing is not completed as the plurality of special effect processing operations set in the picture bracket mode with respect to the image data is recorded in the SDRAM 25. When the control unit 29 judges that there is the previous image data (step S207: Yes), the imaging apparatus 1 proceeds to step S206. Meanwhile, when the control unit 29 judges that there is no previous image data (step S207: No), the imaging apparatus 1 proceeds to step S208 to be described below.

At step S208, the display controller 293 displays the live view image corresponding to the image data for which the image processing unit 16 performs the processing corresponding to the processing item set in the picture mode, on the display unit 21. Thereafter, the imaging apparatus 1 returns to the main routine illustrated in FIG. 6.

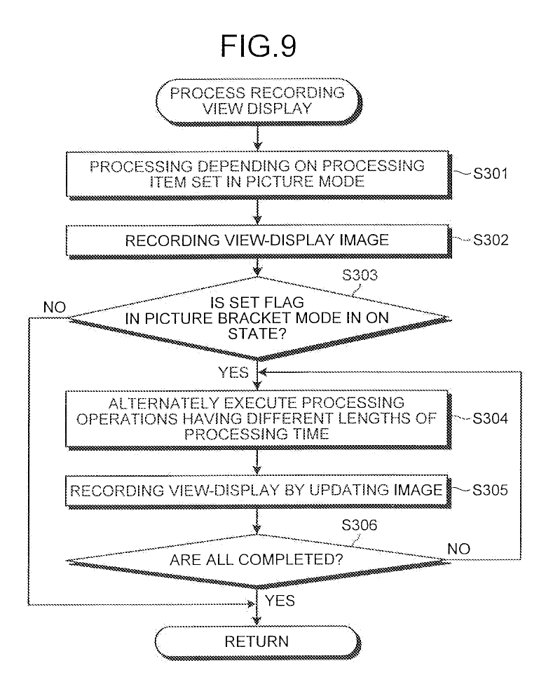

Subsequently, the recording view display processing at step S114 illustrated in FIG. 6 will be described. FIG. 9 is a flowchart illustrating an outline of the recording view display processing illustrated in FIG. 6.

As illustrated in FIG. 9, the image processing unit 16 executes the image processing depending on the processing item set in the picture mode with respect to the image data (step S301). In detail, the image processing unit 16 acquires the image data from the SDRAM 25 through the bus 28, and performs the processing corresponding to the processing item set by the image processing setting portion 291 in the picture mode with respect to the acquired image data and outputs the processed image data to the SDRAM 25.

Subsequently, the display controller 293 recording view-displays the image corresponding to the image data for which the image processing unit 16 performs the processing corresponding to the processing item set in the picture mode on the display unit 21 for a predetermined time period (for example, 2 seconds) (step S302). As a result, the user may verify a shooting content just after shooting.

Thereafter, the control unit 29 judges whether the set flag in the picture bracket mode is in the on state (step S303). When the control unit 29 judges that the set flag in the picture bracket mode is in the on state (step S303: Yes), the imaging apparatus 1 proceeds to step S304 to be described below. Meanwhile, when the control unit 29 judges that the set flag in the picture bracket mode is not in the on state (step S303: No), the imaging apparatus 1 returns to the main routine illustrated in FIG. 6.

At step S304, the image processing controller 292 allows the image processing unit 16 to execute the processing operations corresponding to the plurality of processing items which the image processing setting portion 291 sets in the picture bracket mode in a sequence in which the length of the processing time of the image processing is alternately different by referring to the image processing information table T1 recorded by the image processing information recording portion 263 of the flash memory 26.

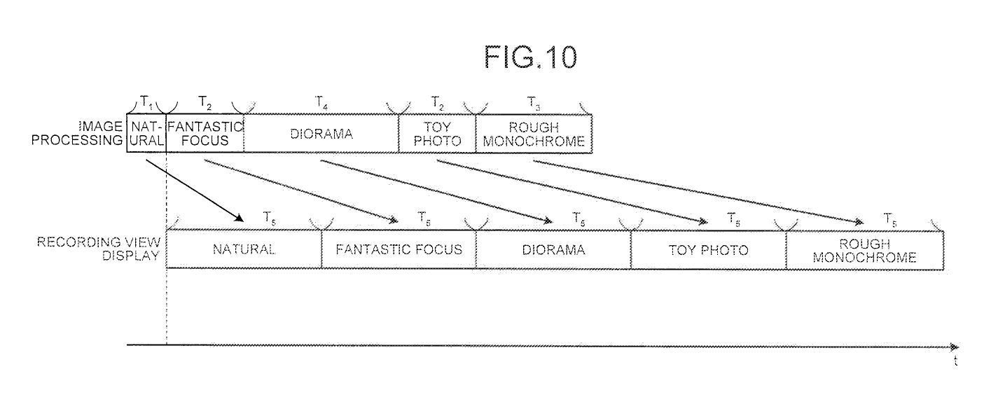

FIG. 10 is a diagram illustrating a timing chart when the image processing controller 292 allows the image processing unit 16 to execute each of the plurality of special effect processing operations and doneness effect processing operations with respect to the image data. Further, in FIG. 10, the image processing setting portion 291 sets the doneness effect processing corresponding to the processing item Natural in the picture bracket mode and sets the special effect processing corresponding to each of the processing items fantastic focus, toy photo, rough monochrome, and diorama.

In FIG. 10, the processing time of the doneness effect processing corresponding to the processing item Natural is represented by T₁, the processing time of the special effect processing corresponding to the processing item fantastic focus is represented by T₂, the processing time of the special effect processing corresponding to the processing item toy photo is represented by T₂, the processing time of the special effect processing corresponding to the processing item rough monochrome is represented by T₃, the processing time of the special effect processing corresponding to the processing item diorama is represented by T₄, and the display time of recording view-displaying the image is represented by T₅. Further, a relational expression between the processing time of the processing corresponding to each processing item and the display time of the recording view display, T₁<T₂<T₃<T₄<T₅ is satisfied.

As illustrated in FIG. 10, the image processing controller 292 allows the image processing unit 16 to execute the processing operations corresponding to the processing items set in the picture bracket mode by changing an array according to the length of the processing time by referring to the image processing information table T1 (see FIG. 3) recorded by the image processing information recording portion 263 of the flash memory 26. In detail, as illustrated in FIG. 10, the image processing controller 292 allows the image processing unit 16 to execute the processing item Natural of which the processing time is the shortest and thereafter, the image processing unit 16 to execute the processing item fantastic focus of which the processing time is second shortest. Subsequently, the image processing controller 292 allows the image processing unit 16 to execute the processing item diorama of which the processing time is the longest and thereafter, the image processing unit 16 to execute the processing item toy photo of which the processing time is third shortest. Thereafter, the image processing controller 292 allows the image processing unit 16 to execute the processing item rough monochrome.

As such, the image processing controller 292 allows the image processing unit 16 to execute the processing operations corresponding to the plurality of processing items which the image processing setting portion 291 sets in the picture bracket mode in a sequence according to the length of the processing time by referring to the image processing information table T1 recorded by the image processing information recording portion 263 of the flash memory 26. As a result, the image processing unit 16 performs processing having a long processing time while the display unit 21 recording view-displays the image. As a result, the display controller 293 may smoothly update the recording view-displayed image at a predetermined interval. Further, since the image processing controller 292 allows the image processing unit 16 to execute the processing operations in a sequence in which the length of the processing time is alternately different, an image of which processing is terminated when the processing is performed in an ascending sequence of the length of the processing time may not be temporarily recorded in the SDRAM 25. As a result, the image processing controller 292 may suppress a capacity temporarily recorded in the SDRAM 25 as compared with the case where the processing is performed in the ascending sequence of the length of the processing time.

After step S304, the display controller 293 recording view-displays on the display unit 21 the image corresponding to the image data for which the image processing unit 16 performs the processing operations corresponding to the plurality of processing items while updating the image at a predetermined timing (for example, every 2 seconds) (step S305).

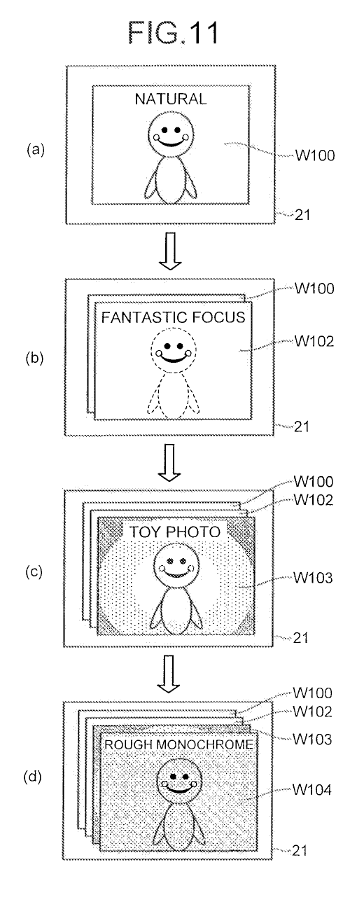

FIG. 11 is a diagram illustrating a method of displaying an image which the display controller 293 allows the display unit 21 to recording view-display.

As illustrated in FIG. 11, the display controller 293 sequentially displays on the display unit 21a plurality of images generated by the image processing unit 16 while superimposing the images with gradual shifts from the left side on a display screen of the display unit 21 (a sequence of FIG. 11(a), FIG. 11(b), FIG. 11(c), and FIG. 11(d)). The images may be superimposed on each other without the shifts, but it can be seen what sheets of brackets are terminated through the shifts. Further, the display controller 293 superimposes and displays the information on the processing item name performed with respect to the images which the display unit 21 sequentially displays (a sequence of Natural, fantastic focus, toy photo, and rough monochrome).

As a result, the user may verify the images subjected to the processing corresponding to the processing item set in the picture bracket mode one by one without operating the playback switch 206 whenever playing back the image data. Further, since the shading effect or airbrushing which exceeds a user's expectation is caused in the image subjected to the special effect processing, there is a possibility that the shading effect or airbrushing will be the user's expectation. As a result, the user verifies the recording view-displayed image displayed by the display unit 21 to immediately judge whether shooting needs to be performed again. Further, since the relationship between the effect of the special effect processing and the processing item name of the special effect processing becomes clear, the user may intuitively determine satisfactory special effect processing or unsatisfactory special effect processing even when the plurality of special effect processed images are displayed in an irregular sequence within a short time.

After step S305, the control unit 29 judges whether the image processing unit 16 completes all of the plurality of processing items set in the picture bracket mode with respect to the image data (step S306). In detail, the control unit 29 judges whether the plurality of doneness effect image data or special effect image data in which the image processing unit 16 performs the plurality of processing items set in the picture bracket mode, respectively, are recorded in the SDRAM 25. When the control unit 29 judges that the image processing unit 16 completes all of the plurality of processing items set in the picture bracket mode with respect to the image data (step S306: Yes), the imaging apparatus 1 returns to the main routine illustrated in FIG. 6. Meanwhile, when the control unit 29 judges that the image processing unit 16 does not complete any of the plurality of processing items set in the picture bracket mode with respect to the image data (step S306: No), the imaging apparatus 1 returns to step S304.

According to the first exemplary embodiment of the present invention described above, the display controller 293 displays on the display unit 21 the plurality of processed images and live view images corresponding to the plurality of image processing data generated in the image processing unit 16 by the image processing controller 292. As a result, the user may intuitively determine a visual effect of an image to be captured before capturing images subjected to a plurality of special effect processing operations by one-time shooting operation while viewing the image displayed by the display unit 21.

Further, according to the first exemplary embodiment of the present invention, the display controller 293 displays on the display unit 21 the plurality of processed images corresponding to the plurality of image processing data generated in the image processing unit 16 by the image processing controller 292 for a predetermined time just after capturing the plurality of processed images. As a result, the user may easily verify the plurality of images subjected to the plurality of special effect processing operations by one-time shooting operation without switching the mode of the imaging apparatus 1 into a playback mode while viewing the image displayed by the display unit 21.

### First Modified Example of First Exemplary Embodiment

In the first exemplary embodiment described above, the display controller 293 may change the position where the plurality of special effect images corresponding to the plurality of special effect image data generated by the image processing unit 16 are superimposed on the live view images displayed on the display unit 21.

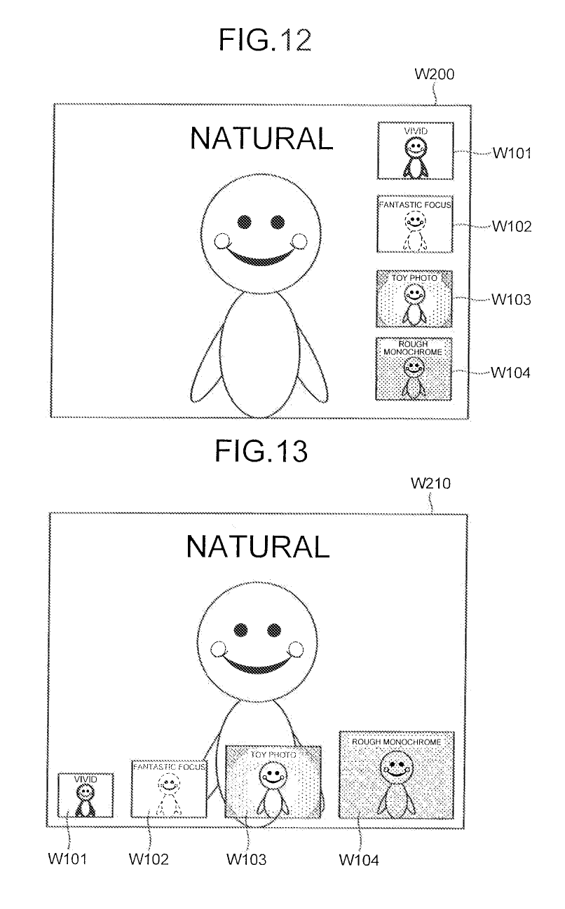

FIG. 12 is a diagram illustrating one example of the live view image which the display controller 293 displays on the display unit 21 according to a first modified example of a first exemplary embodiment of the present invention.

As illustrated in FIG. 12, the display controller 293 may reduce each of the images W101 to W104 generated by the image processing unit 16 and display the reduced images on the display unit 21 vertically in parallel at a right region on a live view image W200. Further, the display controller 293 may superimpose and display “Natural” as information on a processing item name of the live view image W200 displayed by the display unit 21. Further, the display controller 293 may superimpose and display the information on the processing item name of each of the images W101 to W104, for example, the character or icon on each of the images W101 to W104.

### Second Modified Example of First Exemplary Embodiment

In the first exemplary embodiment described above, the display controller 293 may change the sizes of the plurality of special effect images superimposed on the live view images displayed on the display unit 21 to different sizes.

FIG. 13 is a diagram illustrating one example of the live view image which the display controller 293 displays on the display unit 21 according to a second modified example of the first exemplary embodiment of the present invention.

As illustrated in FIG. 13, the display controller 293 may superimpose each of the images W101 to W104 generated by the image processing unit 16 on a live view image W210 and display the superimposed image on the display unit 21 by decreasing a reduction ratio as a user's use frequency increases. As a result, the same effect as in the first exemplary embodiment is given and further, the special effect processing which the user frequently uses may be determined more intuitively. Further, the display controller 293 may superimpose and display “Natural” as information on the processing item name of the live view image W210 displayed by the display unit 21. Further, the display controller 293 may superimpose and display the information on the processing item name of each of the images W101 to W104, for example, the character or icon on each of the images W101 to W104. As a result, since the relationship between the effect of the special effect processing and the processing item name of the special effect processing becomes clear, the user may intuitively determine the satisfactory special effect processing or unsatisfactory special effect processing even when the plurality of special effect processed images are displayed in an irregular sequence within a short time.

### Third Modified Example of First Exemplary Embodiment

In the first exemplary embodiment described above, the display controller 293 may synthesize the plurality of special effect images generated by the image processing unit 16 and the live view images displayed by the display unit 21 to display the synthesized images on the display unit 21.

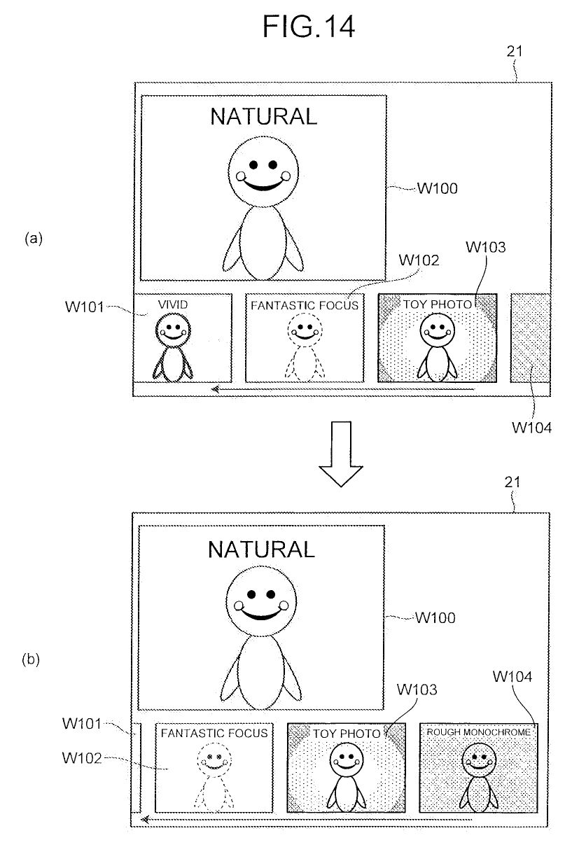

FIG. 14 is a diagram illustrating one example of the live view image which the display controller 293 displays on the display unit 21 according to a third modified example of the first exemplary embodiment of the present invention.

As illustrated in FIG. 14, the display controller 293 displays each of the images W101 to W104 generated by the image processing unit 16 on the display unit 21 while moving (scrolling) each image from the right side to the left side of the display screen of the display unit 21 (from FIG. 14(a) to FIG. 14(b)) and further, reduces the live view image W100 and displays the reduced image on the display unit 21. As a result, an image may be verified which shows the same effect as in the first exemplary embodiment and further, is subjected to the special effect processing or the doneness effect processing while comparing with the live view image W100. Further, the display controller 293 may superimpose and display “Natural” as the information on the processing item name of the live view image W100 displayed by the display unit 21. Further, the display controller 293 may superimpose and display the information on the processing item name of each of the images W101 to W104, for example, the character or icon on each of the images W101 to W104.

### Second Exemplary Embodiment

Subsequently, a second exemplary embodiment of the present invention will be described. The second exemplary embodiment of the present invention is different from the first exemplary embodiment only in the recording view display processing of the operation of the imaging apparatus 1 according to the first exemplary embodiment and has the same configuration as that of the imaging apparatus of the first exemplary embodiment. As a result, hereinafter, only recording view display processing by the imaging apparatus according to the second exemplary embodiment of the present invention will be described.

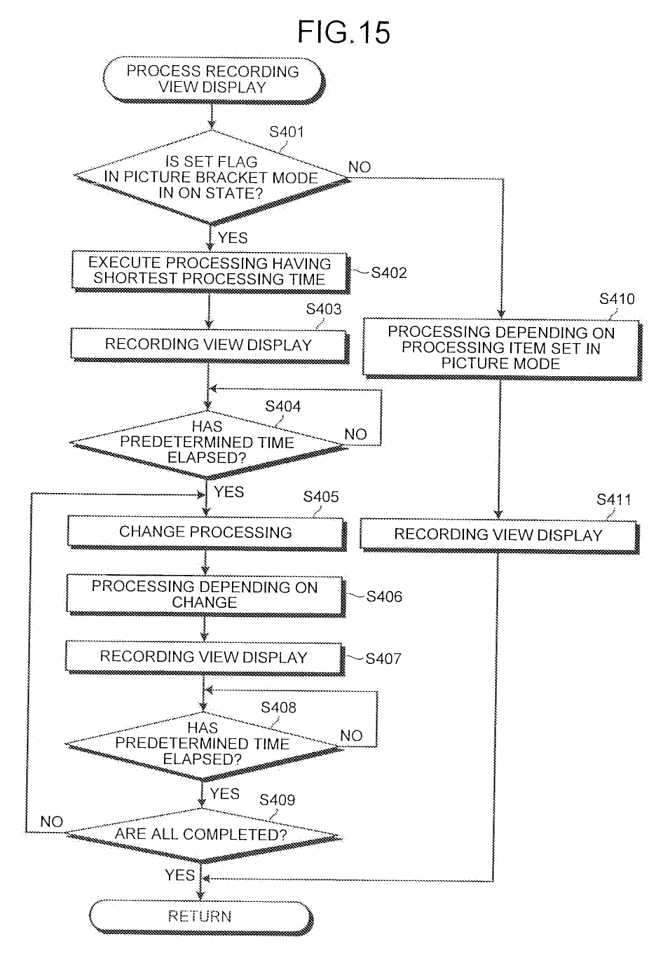

FIG. 15 is a flowchart illustrating an outline of the recording view display processing (step S114 of FIG. 6) performed by the imaging apparatus 1 according to the second exemplary embodiment.

As illustrated in FIG. 15, the case where the set flag in the picture bracket mode is in the on state in the imaging apparatus 1 (step S401: Yes) will be described. In this case, the image processing controller 292 allows the image processing unit 16 to execute processing having the shortest processing time among the processing operations corresponding to the plurality of processing items set in the picture mode and the picture bracket mode by referring to the image processing information table T1 recorded by the image processing information recording portion 263 (step S402).

Subsequently, the display controller 293 recording view-displays the image corresponding to the image data generated by the image processing unit 16 on the display unit 21 (step S403).

Thereafter, the control unit 29 judges whether a predetermined time (for example, 2 seconds) has elapsed after the display unit 21 recording view-displays the image (step S404). When the control unit 29 judges that the predetermined time has not elapsed (step S404: No), the control unit 29 repeats the judgment at step S404. Meanwhile, when the control unit 29 judges that the predetermined time has elapsed (step S404: Yes), the imaging apparatus 1 proceeds to step S405 to be described below.

At step S405, the image processing controller 292 sets the processing corresponding to the processing item set in the image processing unit 16 by the image processing setting portion 291 in the picture bracket mode, changes the processing to processing depending on a processing item which is not yet processed (step S405), and allows the image processing unit 16 to execute processing corresponding to the processing item depending on the change (step S406).

Subsequently, the display controller 293 recording view-displays the image corresponding to the image data image-processed by the image processing unit 16 on the display unit 21 (step S407).

Subsequently, the control unit 29 judges whether a predetermined time (for example, 2 seconds) has elapsed after the display unit 21 recording view-displays the image (step S408). When the control unit 29 judges that the predetermined time has not elapsed (step S408: No), the control unit 29 repeats the judgment at step S408. Meanwhile, when the control unit 29 judges that the predetermined time has elapsed (step S408: Yes), the control unit 29 judges whether all the processing operations corresponding to the plurality of processing items which the image processing setting portion 291 sets in the picture mode and the picture bracket mode in the image processing unit 16 are terminated (step S409). When the control unit 29 judges that any processing operation corresponding to the plurality of processing items is not terminated (step S409: No), the imaging apparatus 1 returns to step S405. Meanwhile, when the control unit 29 judges that all the processing operations corresponding to the plurality of processing items are terminated (step S409: Yes), the imaging apparatus 1 returns to the main routine illustrated in FIG. 6.

Subsequently, the case where the set flag in the picture bracket mode is not in the one state in the imaging apparatus 1 (step S401: No) will be described. In this case, the image processing controller 292 allows the image processing unit 16 to execute processing corresponding to the processing item which the image processing setting portion 291 sets in the picture mode with respect to the image data (step S410).

Subsequently, the display controller 293 recording view-displays the image corresponding to the image data image-processed by the image processing unit 16 on the display unit 21 (step S411). Thereafter, the imaging apparatus 1 returns to the main routine illustrated in FIG. 6.

In the second exemplary embodiment of the present invention as described above, the image processing controller 292 allows the image processing unit 16 to first execute the processing having the shortest processing time among the processing operations corresponding to the plurality of processing items which the image processing setting portion 291 sets in the picture mode and the picture bracket mode in the image processing unit 16 by referring to the image processing information table T1 recorded by the image processing information recording portion 263. As a result, an interval until the display unit 21 first recording view-displays the image may be shortened. As a result, since the user may verify the image image-processed just after shooting through the display unit 21, the user may immediately judge whether reshooting is required.

### Third Exemplary Embodiment

Subsequently, a third exemplary embodiment of the present invention will be described. An imaging apparatus according to the third exemplary embodiment of the present invention is different from the imaging apparatus in the configuration of flash memory. Further, an operation performed by the imaging apparatus according to the third exemplary embodiment of the present invention is different from that that of the exemplary embodiments in the live view display processing and the recording view display processing. As a result, hereinafter, after the configuration different from that of the exemplary embodiments is described, the live view display processing and the recording view display processing of the operation by the imaging apparatus according to the third exemplary embodiment of the present invention will be described. Further, as stated in the drawings, like reference numerals refer to like elements.

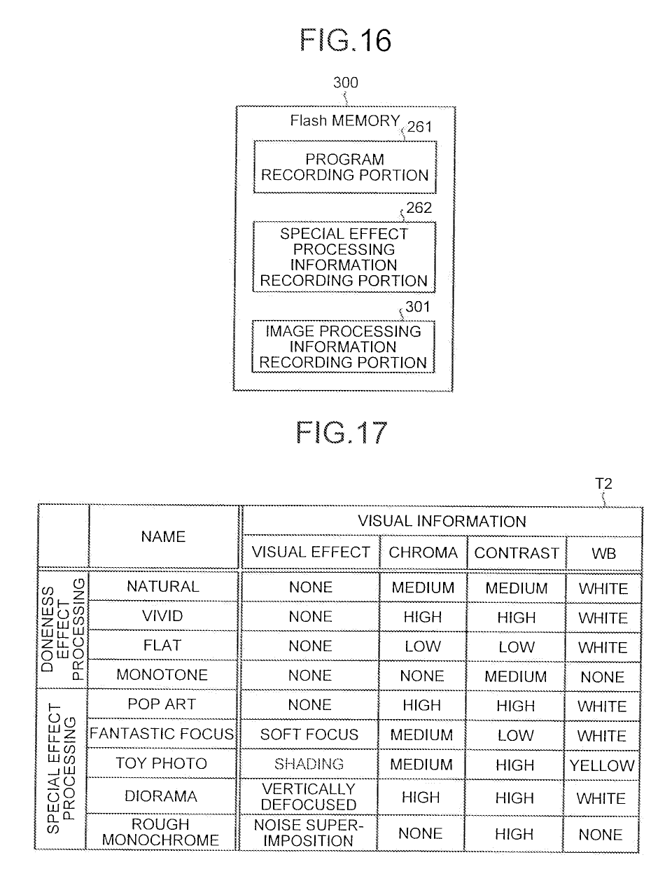

FIG. 16 is a block diagram illustrating a configuration of flash memory provided in an imaging apparatus 1 according to a third exemplary embodiment of the present invention. As illustrated in FIG. 16, the flash memory 300 includes a program recording portion 261, a special effect processing information recording portion 262, and an image processing information recording portion 301.

The image processing information recording portion 301 records image processing information in which visual information corresponds to the plurality of special effect processing operations and doneness effect processing operations which can be executed by the image processing unit 16.

Herein, the image processing information recorded by the image processing information recording portion 301 will be described. FIG. 17 is a diagram illustrating one example of an image processing information table recorded by the image processing information recording portion 301.

In an image processing information table T2 illustrated in FIG. 17, each of the doneness effect processing and the special effect processing which the image processing unit 16 can execute with respect to the image data is described. Further, a plurality of visual information is described to correspond to each of the doneness effect processing and the special effect processing. For example, when the doneness effect processing set in the image processing unit 16 is “Natural”, “none”, “medium”, “medium”, and “white” are described as a visual effect, chroma, contrast, and WB (white balance), respectively. Further, when the special effect processing set in the image processing unit 16 is “fantastic focus”, “soft focus”, “medium”, “low”, and “white” are described as the visual effect, the chroma, the contrast, and the WB, respectively. Herein, the visual effect is an effect by image processing which the user may intuitively determine at the time of viewing the captured image.

As such, in the image processing information table T2, the visual information is described to correspond to each of the doneness effect processing and the special effect processing which the image processing unit 16 can execute.

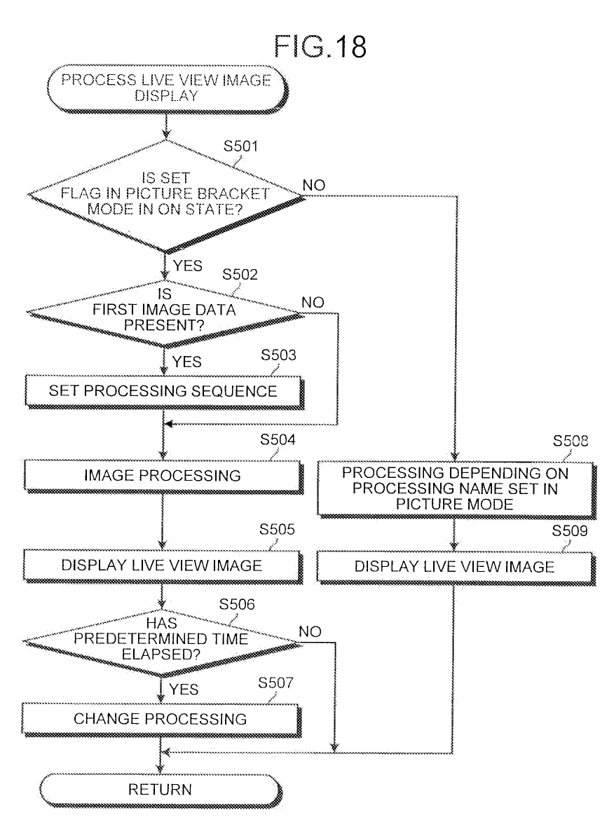

Subsequently, the live view image display processing performed by the imaging apparatus 1 according to the third exemplary embodiment will be described. FIG. 18 is a flowchart illustrating an outline of the live view image display processing (step S111 of FIG. 6) performed by the imaging apparatus 1 according to the third exemplary embodiment.

As illustrated in FIG. 18, the case where the set flag in the picture bracket mode is in the on state in the imaging apparatus 1 (step S501: Yes) will be described. In this case, the control unit 29 judges whether the image data (one frame) generated by the shooting operation of the imaging apparatus 1 is a first image datum (step S502). Herein, the first image data is image data generated by a shooting operation using the electronic shutter just after the picture bracket mode is set in the imaging apparatus 1. When the control unit 29 judges that the image data generated by the shooting operation of the imaging apparatus 1 is the first image data (step S502: Yes), the imaging apparatus 1 proceeds to step S503 to be described below. Meanwhile, when the control unit 29 judges that the image data generated by the shooting operation of the imaging apparatus 1 is not the first image data (step S502: No), the imaging apparatus 1 proceeds to step S504 to be described below.

At step S503, the image processing setting portion 291 sets a sequence of processing operations in which the plurality of processing items set in the picture mode and the picture bracket mode correspond to the processing items executed by the image processing unit 16, respectively, by referring to the image processing information table T2 recorded by the image processing information recording portion 301 (step S503). In detail, the image processing setting portion 291 sets the sequence of the processing operations so that any element are not consecutive in the visual information by referring to the image processing information table T2 recorded by the image processing information recording portion 301. For example, when the plurality of processing items set in the picture mode and the picture bracket mode are “Vivid”, “fantastic focus”, “toy photo”, and “rough monochrome”, the image processing setting portion 291 prevents two processing operations from being consecutively performed because the chromas of “fantastic focus” and “toy photo” are the same as each other as “medium” and sets a sequence of the processing operations which the image processing unit 16 executes in the sequence of “Vivid”, “fantastic focus”, “rough monochrome” and “toy photo”.

Subsequently, the image processing controller 292 allows the image processing setting portion 291 to execute the image processing set in the image processing unit 16 with respect to the image data (step S504).

Thereafter, the display controller 293 displays the live view image corresponding to the image data processed by the image processing unit 16 on the display unit 21 (step S505).

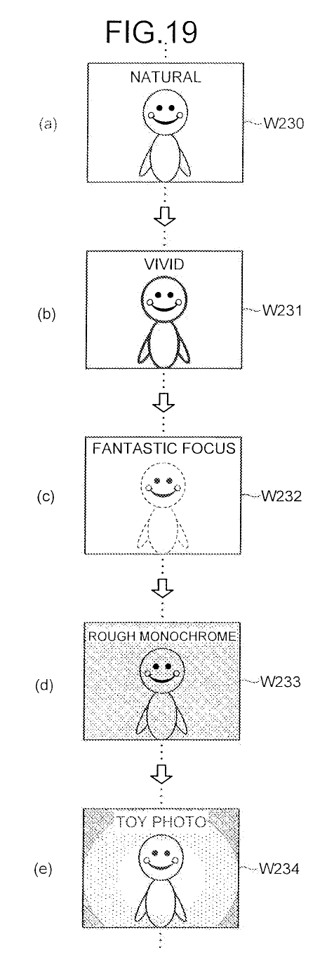

FIG. 19 is a diagram illustrating one example of the live view image which the display controller 293 displays on the display unit 21. Further, FIG. 19 illustrates one representative image of images W230 to W234 corresponding to the processing item, which is processed by the image processing unit 16 among the live view images which the display unit 21 sequentially displays according to the temporal sequence. Further, it is assumed that a plurality of images are present among the respective images W230 to W234. Further, the images W231 to W234 are subjected to processing operations corresponding to the same processing items as the images W101 to W104.

As illustrated in FIG. 19, the display controller 293 follows the sequence of the processing operations set by the image processing setting portion 291 as described above and sequentially displays on the display unit 21 the live view image corresponding to the image data for which the image processing unit 16 performs the processing corresponding to the processing item, according to the temporal sequence (a sequence of FIG. 19(a), FIG. 19(b), FIG. 19(c), FIG. 19(d), and FIG. 19(e)). Further, the display controller 293 superimposes and displays the information on the performed processing item name on the live view images sequentially displayed by the display unit 21 (a sequence of Natural, fantastic focus, toy photo, and rough monochrome).

As such, the live view images displayed by the display unit 21 are sequentially switched, such that the user may intuitively determine the effect of the processing corresponding to the processing item set in the picture bracket mode. Further, since the display controller 293 displays the live view images on the display unit 21 in visually different sequences, the user may more intuitively determine an inter-image effect. Further, since the relationship between the effect of the special effect processing and the processing item name of the special effect processing becomes clear, the user may intuitively determine satisfactory special effect processing or unsatisfactory special effect processing even when the special effect processed images are displayed in an irregular sequence within a short time.

After step S505, the control unit 29 judges whether a predetermined time has elapsed after the image processing performed by the image processing unit 16 with respect to the live view image displayed by the display unit 21 (step S506). When the control unit 29 judges that the predetermined time has elapsed after the image processing performed by the image processing unit 16 (step S506: Yes), the imaging apparatus 1 proceeds to step S507 to be described below. Meanwhile, when the control unit 29 judges that the predetermined time has not elapsed after the image processing performed by the image processing unit 16 (step S506: No), the imaging apparatus 1 returns to the main routine illustrated in FIG. 6.

At step S507, the image processing setting portion 291 changes the processing executed by the image processing unit 16 in the sequence set as step S503. Thereafter, the imaging apparatus 1 returns to the main routine illustrated in FIG. 6.

Subsequently, the case where the set flag in the picture bracket mode is not in the on state in the imaging apparatus 1 (step S501: No) will be described. In this case, the imaging apparatus 1 executes steps S508 and S509 and returns to the main routine illustrated in FIG. 6. Further, since steps S508 and S509 correspond to steps S410 and S411 described in FIG. 15, a description thereof will be omitted.

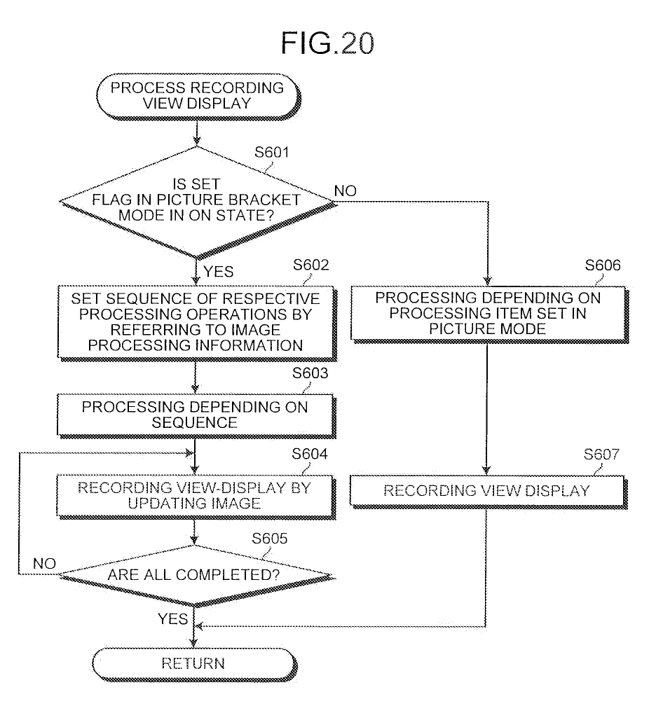

Subsequently, the recording view display processing performed by the imaging apparatus 1 according to the third exemplary embodiment will be described. FIG. 20 is a flowchart illustrating an outline of the recording view display processing (step S114 of FIG. 6) performed by the imaging apparatus 1 according to the third exemplary embodiment.

As illustrated in FIG. 20, the case where the set flag in the picture bracket mode is in the on state in the imaging apparatus 1 (step S601: Yes) will be described. In this case, the image processing setting portion 291 sets a sequence of processing operations corresponding to the plurality of processing items set in the picture mode and the picture bracket mode by referring to the image processing information table T2 recorded by the image processing information recording portion 301 (step S602). In detail, the image processing setting portion 291 sets the sequence of the processing operations so that any element is not consecutive in the visual information by referring to the image processing information table T2 recorded by the image processing information recording portion 301.

Subsequently, the image processing controller 292 follows the sequence of the processing set by the image processing setting portion 291 with respect to the image data and allows the image processing unit 16 to execute the processing corresponding to each of the plurality of processing items (step S603). For example, the image processing unit 16 performs the processing in the sequence of the processing items Vivid, fantastic focus, rough monochrome, and toy photo in sequence. As a result, the imaging apparatus 1 may generate a plurality of image data for which the image processing unit 16 performs each of the plurality of special effect processing operations and doneness effect processing operations.

Subsequently, the display controller 293 updates the images corresponding to the plurality of image data for which the image processing unit 16 performs the plurality of special effect processing operations or doneness effect processing operations every predetermined time (for example, 2 seconds) and recording view-displays the updated images on the display unit 21 (step S604). In detail, the display controller 293 recording view-displays the images corresponding to the plurality of image data for which the image processing unit 16 performs the plurality of special effect processing operations or doneness effect processing operations every predetermined time on the display unit 21 with respect to the captured image data, as illustrated in FIG. 19. As a result, the user may verify an image subjected to the special effect processing or doneness effect processing with respect to the captured image through recording view display even though the captured image is not playback-displayed each time by setting the mode of the imaging apparatus 1 to the playback mode.

Thereafter, the control unit 29 judges whether the image processing unit 16 completes all the processing operations corresponding to the plurality of processing items set by the image processing setting portion 291 (step S605). When the control unit 29 judges that all the processing operations are terminated (step S605: Yes), the imaging apparatus 1 returns to the main routine illustrated in FIG. 6. Meanwhile, when the control unit 29 judges that any processing operation is not terminated (step S605: No), the imaging apparatus 1 returns to step S604.

Subsequently, the case where the set flag in the picture bracket mode is not in the on state in the imaging apparatus 1 (step S601: No) will be described. In this case, the imaging apparatus 1 executes steps S606 and S607 and returns to the main routine illustrated in FIG. 6. Further, since steps S606 and S607 correspond to steps S410 and S411 described in FIG. 15, a description thereof will be omitted.

According to the third exemplary embodiment of the present invention described above, the image processing setting portion 291 sets the processing operations corresponding to the plurality of processing items set in the picture mode and the picture bracket mode in the image processing unit 16 in different sequences so that any element in the visual information is not consecutive by referring to the image processing information table T2 recorded by the image processing information recording portion 301 and the display controller 293 displays on the display unit 21 the live view images corresponding to the plurality of image data for which the image processing unit 16 performs the plurality of special effect processing operations and doneness effect processing operations. As a result, the user may capture the image by easily verifying a difference in visual effect between the special effect processing and the doneness effect processing set in each of the picture mode and the picture bracket mode while viewing the live view image displayed by the display unit 21.

Further, according to the third exemplary embodiment of the present invention, the image processing setting portion 291 sets the processing operations corresponding to the plurality of processing items set in the picture mode and the picture bracket mode in the image processing unit 16 in different sequences so that any element in the visual information is not consecutive by referring to the image processing information table T2 recorded by the image processing information recording portion 301 and the display controller 293 recording view-displays the images on the display unit 21, in a sequence in which processing of the images corresponding to the plurality of image data for which the image processing unit 16 performs the plurality of special effect processing operations and doneness effect processing operations is completed. As a result, the user may easily verify the difference in visual effect between the special effect processing and the doneness effect processing set in each of the picture mode and the picture bracket mode while viewing the image recording view-displayed by the display unit 21 even though the captured image is playback-displayed by setting the mode of the imaging apparatus 1 to the playback mode.

### First Modified Example of Third Exemplary Embodiment

In the third exemplary embodiment, the display controller 293 may change a method for displaying the live view image corresponding to the image data processed by the image processing unit 16.

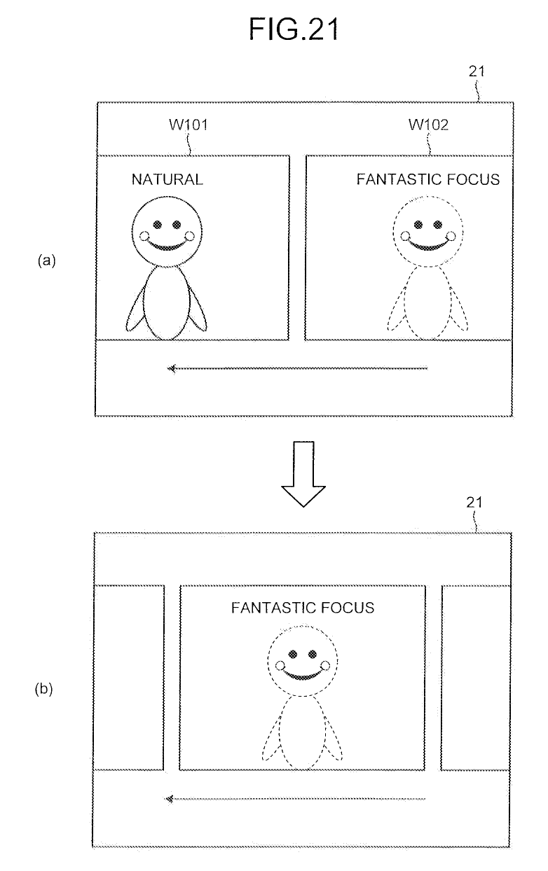

FIG. 21 is a diagram illustrating one example of a live view image which the display controller 293 displays on the display unit 21 according to a first modified example of the third exemplary embodiment of the present invention. Further, FIG. 21 illustrates one representative image among the live view images which the display unit 21 sequentially displays according to the temporal sequence.

As illustrated in FIG. 21, the display controller 293 displays on the display unit 21 the live view images corresponding to the image data for which the image processing unit 16 performs the special effect processing and the doneness effect processing while scrolling the display screen of the display unit 21 from the right side to the left side (from FIG. 21(a) to FIG. 21(b)). In this case, the image processing unit 16 generates two image data subjected to the processing corresponding to the processing item set in the picture bracket mode. As a result, the user may capture the image by comparing the visual effects of the special effect processing and the doneness effect processing set in the picture mode and the picture bracket mode while viewing the live view image displayed by the display unit 21. Further, the display controller 293 may sequentially recording view-display on the display unit 21 the images corresponding to the image data for which the image processing unit 16 performs the special effect processing or the doneness effect processing while scrolling the display screen of the display unit 21 from the right side to the left side. Further, the display controller 293 may display the processing items of the special effect processing or the doneness effect processing performed with respect to the images displayed by the display unit 21.

### Fourth Exemplary Embodiment

Subsequently, a fourth exemplary embodiment of the present invention will be described. The fourth exemplary embodiment of the present invention is different from the first exemplary embodiment in only the recording view-display processing by the imaging apparatus according to the first exemplary embodiment. As a result, hereinafter, only the recording view-display processing by the imaging apparatus according to the fourth exemplary embodiment of the present invention will be described.

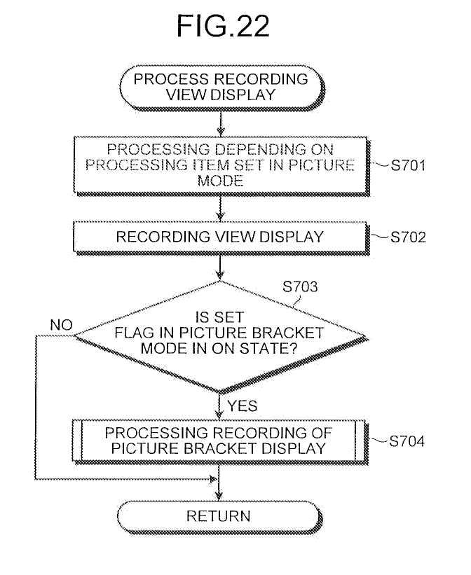

FIG. 22 is a flowchart illustrating an outline of the recording view display processing (step S114 of FIG. 6) performed by the imaging apparatus according to the fourth exemplary embodiment of the present invention.

As illustrated in FIG. 22, the image processing controller 292 allows the image processing unit 16 to execute the processing depending on the processing item which the image processing setting portion 291 set in the image processing unit 16 in the picture mode by the image processing setting portion 291 (step S701).

Subsequently, the display controller 293 recording view-displays the image corresponding to the image data for which the image processing unit 16 performs the processing corresponding to the processing item set in the picture mode on the display unit 21 for only a predetermined time period (for example, 2 seconds) (step S702).

Thereafter, the control unit 29 judges whether the set flag in the picture bracket mode is in the on state in the imaging apparatus 1 (step S703). When the control unit 29 judges whether the set flag in the picture bracket mode is in the on state in the imaging apparatus 1 (step S703: Yes), the imaging apparatus 1 executes picture bracket display recording processing of recording view-displaying each of the images corresponding to the plurality of image data for which the image processing setting portion 291 performs the processing operations corresponding to the plurality of processing items set in the image processing unit 16 in the picture bracket mode on the live view image displayed by the display unit 21 (step S704). Further, the picture bracket display recording processing will be described below in detail. After step S704, the imaging apparatus 1 returns to the main routine illustrated in FIG. 6.

At step S703, the case where the set flag in the picture bracket mode is not in the on state in the imaging apparatus 1 (step S703: No) will be described. In this case, the imaging apparatus 1 returns to the main routine illustrated in FIG. 6.

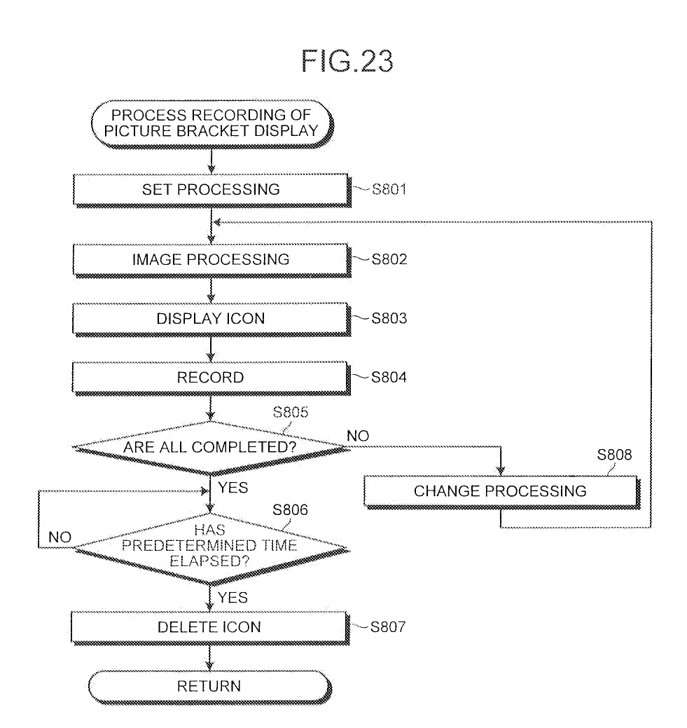

Subsequently, the picture bracket display recording processing at step S704 illustrated in FIG. 22 will be described. FIG. 23 is a flowchart illustrating an outline of the picture bracket display recording processing.

As illustrated in FIG. 23, the image processing setting portion 291 sets the processing corresponding to the processing item set in the picture bracket mode, in the image processing unit 16 (step S801).

Subsequently, the image processing controller 292 allows the image processing unit 16 to execute the processing corresponding to the processing item set by the image processing setting portion 291 with respect to the image data (step S802).

Thereafter, the display controller 293 reduces (resizes) the image corresponding to the image data for which the image processing unit 16 performs the special effect processing or the doneness effect processing at a predetermined magnification, and superimposes and displays the reduced image on the live view image displayed by the display unit 21 as the icon (step S803). In detail, the display controller 293 displays the image subjected to the same processing as in FIG. 8 on the display unit 21. Further, when the display unit 21 displays the reduced image acquired by reducing the images corresponding to the plurality of image data subjected to the plurality of image processing set in the picture bracket mode on the live view image, the display controller 293 may display the icon on the display unit 21 instead of the reduced image.

Subsequently, the image processing controller 292 records in the SDRAM 25 the image data for which the image processing unit 16 performs the processing corresponding to the processing item (step S804).

Thereafter, the control unit 29 judges whether the image processing unit 16 completes all the processing operations set by the image processing setting portion 291 (step S805). When the control unit 29 judges that all the processing operations set by the image processing setting portion 291 are terminated (step S805: Yes), the imaging apparatus 1 proceeds to step S806 to be described below. Meanwhile, when the control unit 29 judges that any processing operation set by the image processing setting portion 291 is not terminated (step S805: No), the imaging apparatus 1 proceeds to step S808 to be described below.

At step S806, the control unit 29 judges whether a predetermined time (for example, 3 seconds) has elapsed after the icon is superimposed and displayed on the live view image displayed by the display unit 21 (step S806). When the control unit 29 judges that the predetermined time has not elapsed (step S806: No), the control unit 29 repeats the judgment at step S806. Meanwhile, when the control unit 29 judges that the predetermined time has elapsed (step S806: Yes), the imaging apparatus 1 proceeds to step S807.

Subsequently, the display controller 293 removes all operations which are superimposed and displayed on the live view image displayed by the display unit 21 (step S807) and the imaging apparatus 1 returns to the main routine illustrated in FIG. 6.

At step S805, the case where the control unit 29 judges that any processing operation set by the image processing setting portion 291 is not terminated (step S805: No) will be described. In this case, the image processing setting portion 291 sets the processing executed by the image processing unit 16 in the picture bracket mode and changes the mode according to a processing item which has not yet been processed (step S808), and the imaging apparatus 1 returns to step S802.

According to the fourth exemplary embodiment of the present invention described above, the display controller 293 reduces the image corresponding to the image data for which the image processing unit 16 performs the special effect processing or the doneness effect processing at a predetermined magnification, and superimposes and displays the reduced image on the live view image displayed by the display unit 21 as the icon. As a result, the display controller 293 may display the live view image on the display unit 21. As a result, the user may adjust the angle of view or composition which is shot while verifying the processed image.

Further, according to the fourth exemplary embodiment of the present invention, the user may verify the visual effects of the processing operations corresponding to the processing items set in each of the picture mode and the picture bracket mode while viewing the icon on the live view image displayed by the display unit 21 even though the captured image is not playback-displayed by setting the mode of the imaging apparatus 1 to the playback mode. As a result, the user may immediately judge whether reshooting is required.

### Other Exemplary Embodiments

In the exemplary embodiments, various pieces of information recorded in the program recording portion, the special effect processing information recording portion, and the image processing information recording portion may be updated or modified by accessing an external processing apparatus such as a personal computer or a server through the Internet. As a result, the imaging apparatus may perform shooting by combining a newly added shooting mode, the special effect processing, and the doneness effect processing.

Further, in the exemplary embodiments, a type of the special effect processing is not limited to the above description and for example, art, a ball, a color mask, a cube, a mirror, a mosaic, a sepia, a black-and-white wave, a ball frame, a balloon, rough monochrome, a gentle sepia, a rock, oil painting, a watercolor, and a sketch may be added.

Further, in the exemplary embodiments, the imaging apparatus includes one image processing unit, but the number of the image processing units is not limited and for example, the number of the image processing units may be two.

Further, in the exemplary embodiments, the image processing setting portion 291 may cancel or change the special effect processing set in the image processing unit 16 by operating the shooting mode change-over switch or the lens operating unit.

Besides, in the exemplary embodiments, the display of the live view image displayed by the display unit has been described, but for example, the present invention may be applied even to an external electronic view finder which can be attached to and detached from the body part 2.

Moreover, in the exemplary embodiments, the display of the live view image displayed by the display unit has been described, but for example, the electronic view finder is installed in the body part 2 apart from the display unit and the present invention may be applied to the electronic view finder.

Further, in the exemplary embodiments, the lens part could have been attached to and detachable from the body part, but the lens part and the body part may be formed integrally with each other.

In addition, in the exemplary embodiments, a single-lens digital camera has been described as the imaging apparatus, but for example, the imaging apparatus may be applied to various electronic apparatuses with a shooting function, such as a digital video camera, a camera cellular phone, or a personal computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging apparatus, comprising:
a shooting unit that consecutively generates electronic image data by imaging a subject and photoelectrically converting the imaged subject;
a display unit that displays images corresponding to the image data in a generation sequence;
an image processing unit that generates processed image data by performing special effect processing of generating a visual effect by combining a plurality of image processing operations with respect to the image data;
an image processing controller that causes to generate a plurality of processed image data by allowing the image processing unit to perform the plurality of kinds of special effect processing operations with respect to the image data when there are the plurality of kinds of special effect processing operations to be performed by the image processing unit; and
a display controller that collectively displays one or a plurality of processed images corresponding to at least some of the plurality of processed image data generated by the image processing unit and an image corresponding to the image data on the display unit.

2. The imaging apparatus according to claim 1, further comprising:
an input unit that receives an input of an instruction signal of instructing the special effect processing performed by the image processing unit; and
an image processing setting portion that sets the special effect processing to be performed by the image processing unit according to the instruction signal inputted by the input unit.

3. The imaging apparatus according to claim 2, wherein:
the image processing unit consecutively generates the processed image data by performing any one of the plurality of special effect processing operations set by the image processing setting portion according to a temporal sequence with respect to the image data, and
the display controller displays the processed image corresponding to the processed image data consecutively generated by the image processing unit on the display unit according to the generation sequence.

4. The imaging apparatus according to claim 3, wherein the display controller displays the plurality of processed images on the display unit while sequentially switching the plurality of processed images.

5. The imaging apparatus according to claim 4, wherein the display controller superimposes and displays information on a processing item name of the processed image displayed by the display unit.

6. The imaging apparatus according to claim 5, further comprising:
an image processing information recording portion that records image processing information in which the plurality of special effect processing operations executable by the image processing unit correspond to visual information,
wherein the display controller displays the plurality of processed images on the display unit in a visually different sequence by referring to the visual information recorded by the image processing information recording portion.

7. The imaging apparatus according to claim 6, wherein the visual information includes at least one of a visual effect, chroma, contrast, and a white balance.

8. The imaging apparatus according to claim 7, wherein the display controller displays reduced images acquired by reducing the plurality of processed images on the display unit.

9. The imaging apparatus according to claim 8, wherein image processing combined by the special effect processing operations is any one of airbrushing, shading addition processing, noise superimposition processing, and image synthesis processing.

10. The imaging apparatus according to claim 9, wherein:
the image processing unit is capable of further generating doneness image data by performing doneness effect processing of generating a doneness effect according to a predetermined shooting condition,
the input unit is capable of further receiving inputs of a plurality of instruction signals instructing processing contents of the special effect processing and the doneness effect processing, and
the image processing setting portion sets the special effect processing and the doneness effect processing according to the instruction signal inputted by the input unit.

11. The imaging apparatus according to claim 10, wherein:
the input unit has a release switch receiving an input of a release signal instructing to shoot to the corresponding imaging apparatus, and
the display controller deletes the plurality of processed images displayed by the display unit when the input of the release signal is received from the release switch.

12. The imaging apparatus according to claim 3, wherein the display controller displays the plurality of processed images on the display unit while moving the processed images on a display screen of the display unit.

13. The imaging apparatus according to claim 12, wherein the display controller superimposes and displays information on a processing item name of the processed image displayed by the display unit.

14. The imaging apparatus according to claim 13, further comprising:
an image processing information recording portion that records image processing information in which the plurality of special effect processing operations executable by the image processing unit correspond to visual information,
wherein the display controller displays the plurality of processed images on the display unit in a visually different sequence by referring to the visual information recorded by the image processing information recording portion.

15. The imaging apparatus according to claim 14, wherein the visual information includes at least one of a visual effect, chroma, contrast, and a white balance.

16. The imaging apparatus according to claim 15, wherein the display controller displays reduced images acquired by reducing the plurality of processed images on the display unit.

17. The imaging apparatus according to claim 16, wherein image processing combined by the special effect processing operations is any one of airbrushing, shading addition processing, noise superimposition processing, and image synthesis processing.

18. The imaging apparatus according to claim 17, wherein:
the image processing unit is capable of further generating doneness image data by performing doneness effect processing of generating a doneness effect according to a predetermined shooting condition,
the input unit is capable of further receiving inputs of a plurality of instruction signals instructing processing contents of the special effect processing and the doneness effect processing, and
the image processing setting portion sets the special effect processing and the doneness effect processing according to the instruction signal inputted by the input unit.

19. An imaging method performed by an imaging apparatus including a shooting unit that consecutively generates electronic image data by imaging a subject and photoelectrically converting the imaged subject and a display unit that displays images corresponding to the image data in a generation sequence, the method comprising:
generating processed image data by performing special effect processing of generating a visual effect by combining a plurality of image processing operations with respect to the image data;
generating a plurality of processed image data by performing the plurality of kinds of special effect processing operations in the image processing with respect to one image datum when there are the plurality of special effect processing operations; and
collectively displaying one or a plurality of processed images corresponding to at least some of the plurality of processed image data generated by the image processing unit and an image corresponding to one image datum on the display unit.

20. A non-transitory computer-readable storage medium with an executable program stored thereon, wherein the program instructs a processor of an imaging apparatus including a shooting unit that consecutively generates electronic image data by imaging a subject and photoelectrically converting the imaged subject and a display unit that displays images corresponding to the image data in a generation sequence to perform:
generating processed image data by performing special effect processing of generating a visual effect by combining a plurality of image processing operations with respect to the image data;
generating a plurality of processed image data by performing the plurality of kinds of special effect processing operations in the image processing with respect to one image datum when there are the plurality of kinds of special effect processing operations; and
collectively displaying one or a plurality of processed images corresponding to at least some of the plurality of processed image data and an image corresponding to one image datum on the display unit.
